(19) United States
(12) Patent Application Publication
(10) Pub. No.: US 2024/0335771 A1
(43) Pub. Date: Oct. 10, 2024

(54) SCREEN INTAKE

(71) Applicant: Johnson Screens, Inc., New Brighton, MN (US)

(72) Inventors: Warren Berg, New Brighton, MN (US); Daryn Bertelson, New Brighton, MN (US); Denys Visser, Queensland (AU)

(21) Appl. No.: 18/293,751

(22) PCT Filed: Aug. 1, 2022
(86) PCT No.: PCT/US2022/039084

§ 371 Date: Jan. 30, 2024

Related U.S. Application Data
(60) Provisional application No. 63/227,851, filed on Jul. 30, 2021.

(51) Int. Cl. B01D 29/07

(52) U.S. Cl. CPC B01D 29/071; B01D 2201/0415

(57) ABSTRACT

An intake screen assembly having a domed or dome-like upper screen structure mounted above a central intake structure. The domed or dome-like upper screen structure is constructed such that an interior portion closely conforms to a key flow velocity isosurface without requiring additional internal flow controls or flow modifying structures to achieve desired flow velocities at any point on a screen surface. The central intake structure can define an upper flange surface to which the domed or dome-like upper screen structure is operably coupled. The domed or dome-like upper screen structure can be mounted to a perimeter of the central intake structure at a point spaced away from an intake opening. The domed or dome-like upper screen structure can include a plurality of arcuate or flat filter screen panels. An air burst system can be attached to the central intake structure to backwash the domed or dome-like upper screen structure.

### PRIORITY CLAIM

The present application claims priority to U.S. Provisional Application Ser. No. 63/227,851 filed Jul. 30, 2021 and entitled, “SCREEN INTAKE”, which is hereby incorporated by reference in its entirety.

### FIELD OF THE INVENTION

The present invention is directed to screen intakes for filtering incoming water from a water source. More specifically, the present invention is directed to a screen intake having a domed or dome-like configuration defining an internal volume which closely mimics a key flow velocity isosurface at an intake pipe.

### BACKGROUND

Water collection systems are typically used to provide water to end users such as manufacturing plants, cities, irrigation systems, and power generation facilities located adjacent to a body of water such as a river, lake, or salt water body. The end users may employ this type of system as an alternative to drilling water wells or buying water directly from a municipal source. Additionally, use of these systems may be determined by the location of the end user, for example remote locations where water from a municipal source and/or electrical power to operate pumps is not readily available. These water collection systems are advantageous in that they can be operated efficiently and economically with an ability to adapt to varying water and environmental conditions.

Conventional water collection systems typically use an inlet pipe that is adapted to transport water from a position submerged in a body of water to an end user located adjacent to or proximate the body of water. An inlet pipe is generally submerged in the body of water and the end of the inlet pipe is typically coupled to an intake screen assembly that defines one or more filtering members. One common intake screen configuration is a Tee-style configuration having two filtering screens on opposing ends. A typical construction for large intake screen assemblies is a flanged tee section with two screen cylinders that are cantilevered from opposite ends of the tee section, and with solid closures such as flat plates, cones, or dished heads on the distal ends of each screen cylinder. These closures can be removable, or include access portals within their design. The separate components of the assemblies are usually welded together.

Regardless of the specific configuration, the screen intakes are generally configured to prevent waterborne debris of a certain size, from entering the inlet pipe. At the same time, the screen intakes must be designed to protect aquatic life while filtering debris along the length of the intake screen surfaces. To do this, the flow velocity through the screens should be kept below a maximum peak level, which may be about 0.5 ft/s or other limits that are defined by local requirements and/or specifications. One way to control the flow velocity at the screen's surface is to use flow modifiers inside the screen intake. For example, the Johnson Screens® brand of screen intakes improves flow uniformity across the filtering screens by using flow modifiers as disclosed in U.S. Pat. No. 6,051,131 and U.S. Patent Publication 2012/0298572, the disclosures of each being incorporated herein by reference in their entirety.

While internal flow modifiers can provide for uniform flow velocities across the filtering screens, their design can be complex and they can add significant cost to the screen intake. As such, it would be advantageous to improve upon screen intake designs such that the goal of uniform flow velocity across the filtering screens could be achieved without necessitating internal flow controls and flow modifiers.

### SUMMARY

As disclosed herein, an intake screen assembly according to the present invention can comprise a domed or dome-like upper screen structure that is mounted above a central intake structure. Generally, the various disclosed embodiments of the domed or dome-like intake screen assembly can be constructed such that an interior volume of the dome or dome-like intake screen assembly closely conforms to a key flow velocity isosurface such that additional internal flow control or flow modifying structures are unnecessary to achieve desired flow velocities at any point on a screen surface. In some embodiments, the central intake structure can define an upper flange surface to which the domed or dome-like upper screen structure is operably coupled. In these embodiments, the upper flange surface can generally define a flange perimeter surrounding a central inlet of the central intake structure, wherein the flange perimeter defines a 360° perimeter. In alternative embodiments, the domed or dome-like upper screen structure can be mounted to a perimeter of the central intake structure at a point spaced away from an intake opening. The domed or dome-like upper screen structure is generally formed of a plurality of filter screen panels. The filter screen panels can comprise arcuate filter screens or alternatively, can comprise a plurality of flat screen panels that combine to define domed or dome-like portions of polyhedrons, for example, geodesic domes formed from triangular screen panels or a regular dodecahedron dome formed from pentagonal screen panels. The domed or dome-like upper screen structure can define a hemispherical, upper screen structure. The domed or dome-like upper screen structure can define a dome circumference defined between opposed sides of the domed upper screen structure and an uppermost point of the domed upper screen structure, wherein the dome circumference is greater than 180° and less than 360° and can resemble a partial toroidal shape. The domed or dome-like upper screen structure can define a dome circumference defined between opposed sides of the domed upper screen structure and an uppermost point of the domed upper screen structure of less than 180°. The screen assembly can comprise a circular backwash duct mounted to a lower flange surface of the central intake structure or alternatively, mounted directly to or integrated as part of the central intake structure wherein the circular backwash duct essentially surrounds a perimeter defined by the central inlet of the central intake structure.

As disclosed herein, a screen intake assembly according to the present invention has a flow velocity through a screen surface that does not exceed a desired limit at any point across the screen surface absent any additional internal flow controls or internal flow modifiers. The screen intake assembly includes a domed or dome-like screen structure mounted to a central intake structure wherein an interior volume can be selected and configured such that a key flow velocity isosurface defined about a central aperture of the central intake structure is closely simulated and encompassed within the interior volume. Generally, absent any additional internal flow or internal flow modifiers, the key flow velocity isosurface will form a non-developable shape extending from the central aperture. In some embodiments, a screen radius measured from a center point of a central aperture to any point on the screen surface is approximately equal. The domed or dome-like screen structure generally includes a plurality of filter screens, said filter screens have a developable shape such as, for example, flat or arcuate filter screens. The plurality of filter screens can be retained between a frame structure coupled to the central intake structure. The central intake structure includes an intake pipe delivering filtered water to a point of use. The intake pipe can have a pipe diameter equal to the central aperture or the pipe diameter can transition to be less than the central aperture. A circular backwash duct can be operably incorporated below the central aperture, whereby a plurality of air burst apertures deliver pressurized air into the domed or dome-like screen structure to backwash and remove debris that can accumulate on the domed or dome-like screen structure.

In some embodiments, a screen intake assembly of the present invention includes an upper domed or dome-like screen structure having a hemispherical or hemispherical approximating shape. In some of these embodiments, a radius measured from a center point of a central aperture is approximately the same regardless of where the radius is measured on the upper domed or dome-like screen structure.

In some embodiments, a screen intake assembly of the present invention includes an upper domed or dome-like screen structure having a geodesic shape, such as, for example, a polyhedron formed from triangular screen panels or a dodecahedron formed from pentagonal screen panels.

In some embodiments, a screen intake assembly of the present invention includes a dome circumference defined between opposed sides of a domed or dome-like upper screen structure and an uppermost point of the domed or dome-like upper screen structure, wherein the dome circumference is greater than 180° and less than 360°.

In some embodiments, a screen intake assembly of the present invention includes an upper domed or dome-like structure defining a dome circumference defined between opposed sides of the domed or dome-like upper screen structure and an uppermost point of the domed or dome-like upper screen structure of less than 180°.

In another aspect, the invention comprises a method for managing flow velocity across a screen surface of an intake screen assembly by attaching a domed or dome-like upper screen structure to a central intake structure. Generally, the method can comprise configuring the domed or dome-like upper screen structure such that an interior region of the domed or dome-like upper screen structure encompasses a key flow velocity isosurface defined by fluid entering a central aperture of the central intake structure. In some embodiments, a center point of a central aperture on the central intake structure is approximately equidistant to any part of a screen surface defined on the domed or hemispherical upper screen structure.

In yet another aspect, the invention comprises a method for backwashing a domed or dome-like upper screen structure of an intake screen assembly by coupling an air burst system to a central intake structure below the domed or dome-like upper screen structure. In some embodiments, the air burst system can be mounted to a bottom flange surface of an upper coupling flange to which the domed or dome-like upper screen structure is attached. Alternatively, the air burst system can be directly attached to or integrated into the central intake structure. The method can further comprise supplying pressurized air to the air burst system and directing the pressurized air through a plurality of air burst apertures in fluid contact with an interior portion of the domed or dome-like upper screen structure.

As used throughout the present disclosure, the term “key flow velocity isosurface” is defined as the outer boundary of a high velocity flow region the screen surface must remain beyond (fully encompass) so as to keep a thru-slot velocity at all points of the upper domed or dome-like upper screen structure below a prescribed limit. As an example, many jurisdictions and regulatory authorities require an intake screen have a thru-slot velocity not exceeding 0.5 ft/sec to protect aquatic life.

As used throughout the present disclosure, the term “non-developable surface” describes a surface having double curvature, for example, along both an x-axis and a y-axis of a screen surface, and that cannot otherwise be flattened along a plane.

As used throughout the present disclosure, the term “developable surface”, describes a surface that can be flattened along a plane defined by an x-axis and y-axis of a screen surface.

As used throughout the present disclosure, the term “developable surface” can be used in reference to both a flat screen surface or a screen surface that has been formed to be arcuate along a single axis and can be flattened, for example, an elipse.

As used throughout the present disclosure, the term “domed or dome-like” refers to a shape constituting a portion of a sphere, for example, a hemisphere or arcuate shapes having less than or greater than 180 digress of arc. “Domed or dome-like” further refers to shapes attempting to simulate spherical shapes for instance, geodesic shapes. “Domed or dome-like” can further include shapes having spherical portions such as, for example, toroidal shapes.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1a is a side view illustration a key flow velocity isosurface for an intake pipe absent any screening element.

FIG. 1b is a partially hidden section view of an intake screen assembly of the prior art.

FIG. 1c is a section view of the intake screen assembly of FIG. 1b illustrating a key flow velocity isosurface.

FIG. 2 is a front view of an intake screen assembly according to an embodiment of the present invention.

FIG. 2a is a section view of the intake screen assembly of FIG. 2 illustrating a key flow velocity isosurface.

FIG. 3 is a perspective, front view of the intake screen assembly of FIG. 2.

FIG. 4 is a side view of the intake screen assembly of FIG. 2.

FIG. 5 is a top view of the intake screen assembly of FIG. 2.

FIG. 6 is a front view of a frame assembly attached to a central intake structure used in constructing the intake screen assembly of FIG. 2.

FIG. 7 is a perspective view of the frame assembly of FIG. 6.

FIG. 8 is a top view of the frame assembly of FIG. 6.

FIG. 9 is a perspective view of an arcuate filter screen captured between a portion of the frame assembly of FIG. 6.

FIG. 10 is an interior side view of the arcuate filter screen of FIG. 9.

FIG. 11 is an exterior side view of the arcuate filter screen of FIG. 9.

FIG. 12 is an exterior, perspective view of an arcuate filter screen according to an embodiment of the present invention.

FIG. 13 is an interior, perspective view of the arcuate filter screen of FIG. 12.

FIG. 14 is a side view of the arcuate filter screen of FIG. 12.

FIG. 15 is a perspective view of a central intake structure according to a representative embodiment of the present invention.

FIG. 16 is a top view of the central intake structure of FIG. 15.

FIG. 17 is a front view of the central intake structure of FIG. 15.

FIG. 18 is a bottom view of the central intake structure of FIG. 15.

FIG. 19 is a bottom, perspective view of the central intake structure of FIG. 15.

FIG. 20 is a front perspective view of an arcuate screen filter captured by a frame assembly according to an embodiment of the present invention.

FIG. 21 is a side perspective view of the arcuate filter screen captured by the frame assembly of FIG. 20.

FIG. 22 is a side perspective view illustrating a screen radius of an arcuate filter screen according to an embodiment of the present invention.

FIG. 23 is a side perspective view of an intake screen assembly according to another embodiment of the present invention.

FIG. 24 is a top view of the intake screen assembly of FIG. 23.

FIG. 25 is a side view of a central intake structure according to another embodiment of the present invention.

FIG. 26 is a section view of the central intake structure of FIG. 25.

FIG. 27 is a bottom perspective view of the central intake structure of FIG. 25.

FIG. 28 is a side view of a central intake structure according to another embodiment of the present invention.

FIG. 29 is a section view of the central intake structure of FIG. 28.

FIG. 30 is a bottom perspective view of the central intake structure of FIG. 28.

FIG. 31 is a side view of the intake screen assembly of FIG. 2 with an air burst assembly according to an embodiment of the present invention.

FIG. 32 is a bottom perspective view of the intake screen assembly of FIG. 31.

FIG. 33 is a bottom view of the intake screen assembly of FIG. 31.

FIG. 34 is a top view of a central intake structure for use with the air burst assembly of FIG. 31.

FIG. 35 is a bottom perspective view of the intake screen assembly of FIG. 31 with a bottom duct wall removed to show the interior of the air burst assembly.

FIG. 36 is a side view of an intake screen assembly according to another embodiment of the present invention.

FIG. 37 is a front view of the intake screen assembly of FIG. 36.

FIG. 38 is a perspective, rear view of the intake screen assembly of FIG. 36.

FIG. 39 is a perspective, top view of the intake screen assembly of FIG. 36.

FIG. 40 is a top view of the intake screen assembly of FIG. 36.

FIG. 41 is a side view of an intake screen assembly according to another embodiment of the present invention.

FIG. 42 is a perspective view of the intake screen assembly of FIG. 41.

FIG. 43 is a top view of the intake screen assembly of FIG. 41.

FIG. 44 is a partially hidden perspective view of the intake screen assembly of FIG. 41.

FIG. 45 is a rear view of an intake screen assembly according to another embodiment of the present invention.

FIG. 46 is a side view of the intake screen assembly of FIG. 45

FIG. 47 is a perspective view of the intake screen assembly of FIG. 45.

FIG. 48 is a perspective view of the intake screen assembly of FIG. 45.

FIG. 49 is a bottom view of the intake screen assembly of FIG. 45.

FIG. 50 is a section view of the intake screen assembly of FIG. 45.

FIG. 51 is a partially hidden perspective view of the intake screen assembly of FIG. 45

FIG. 52 is a rear view of an intake screen assembly according to another embodiment of the present invention.

FIG. 53 is a side view of the intake screen assembly of FIG. 52.

FIG. 54 is a top view of the intake screen assembly of FIG. 52.

FIG. 55 is a bottom view of the intake screen assembly of FIG. 52.

FIG. 56 is a partially hidden perspective view of the intake screen assembly of FIG. 52.

FIG. 57 is a section view of the intake screen assembly of FIG. 52.

FIG. 58 is a front view of an intake screen assembly according to another embodiment of the present invention.

FIG. 59 is a top, perspective view of the intake screen assembly of FIG. 58.

FIG. 60 is a bottom, perspective view of the intake screen assembly of FIG. 58.

FIG. 61 is a partially hidden perspective view of the intake screen assembly of FIG. 58.

FIG. 62 is a side view of a central intake structure of the intake screen assembly of FIG. 58.

FIG. 63 is a side view of an embodiment of an intake pipe for use with the intake screen assembly of FIG. 58.

FIG. 64 is a top, perspective view of the intake pipe of FIG. 63.

FIG. 65 is a side view of an embodiment of an intake pipe for use with the intake screen assembly of FIG. 58.

FIG. 66 is a top, perspective view of the intake pipe of FIG. 65.

FIG. 67 is a side view of an intake screen assembly having a side access central intake structure according to an embodiment of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

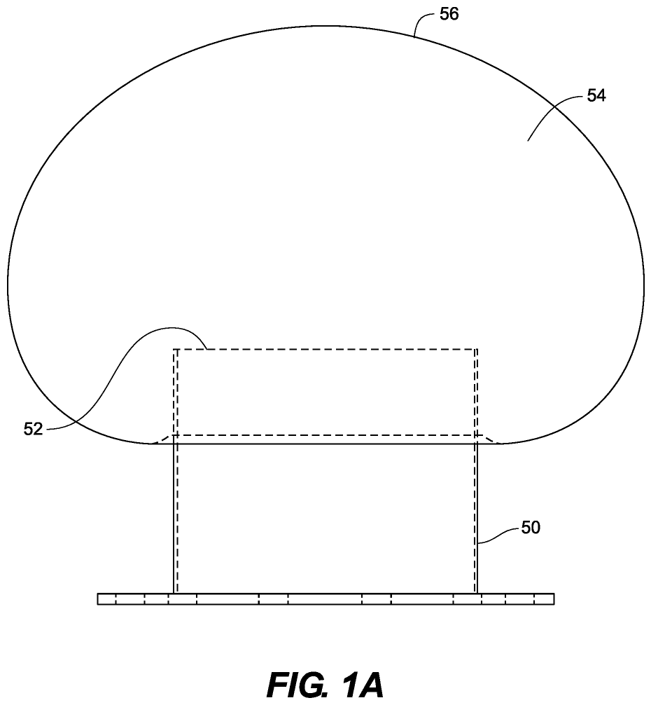

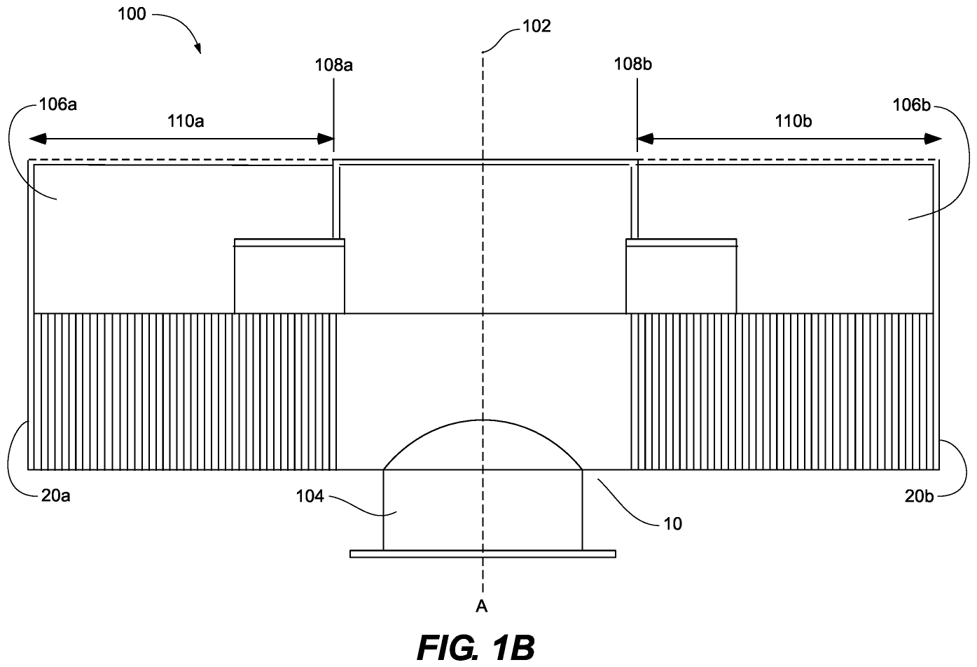

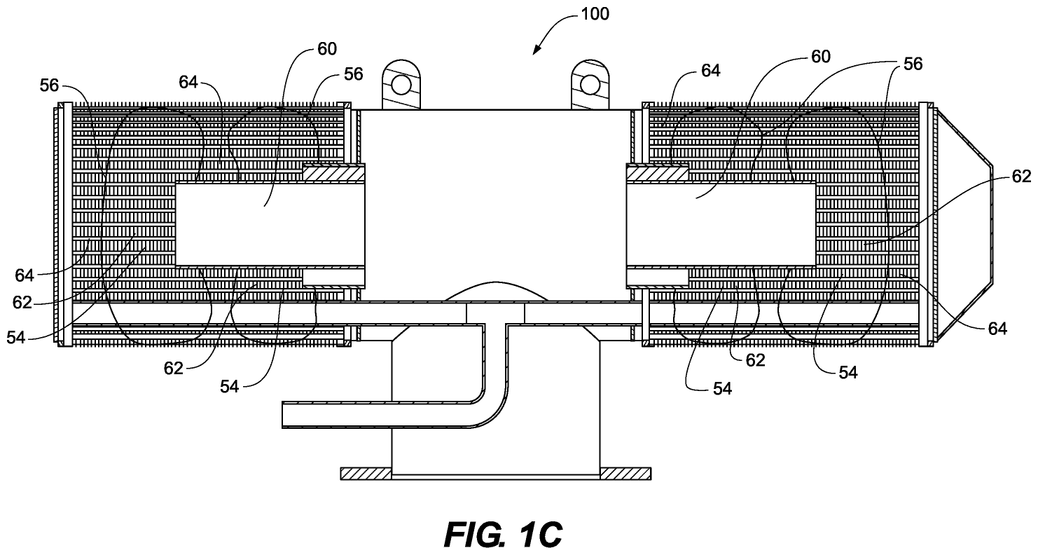

FIG. 1a illustrates an intake pipe 50 positioned within a body of water. Absent any restrictions or modifiers, drawing water into an opening 52 in the intake pipe 50 will define a high flow velocity region 54 that surrounds the opening 52. Generally, flow velocities within the high flow velocity region 54 will increase in speed as flow approaches the opening. The key flow velocity isosurface 56 bounding the high flow velocity region 54 delineates that region which the screen surface must fully encompass.

FIG. 1b illustrates a conventional intake screen assembly 100 of the prior art. An intake screen assembly 100 can generally comprise an intake member or other body shown in the form of a central, flanged tee-section 10, one or more closure members shown as end plates 20a, 20b, a center manifold 102, a lower portion 104, one or more screen portions 106a, 106b, and one or more manifold walls 108a, 108b. In embodiments, the approximate center of screen intake assembly 100 is shown along axis A. Center manifold 102 extends substantially and continually from axis A to manifold wall 108a and 108b, and is comprised of a material that does not allow fluid intake or inflow, such as stainless steel or copper-nickel pipe or tubing. Screen portions 106a, 106b each have a corresponding screen length 110a, 110b that is defined between the respective manifold wall 108a, 108b to the respective end plate 20a, 20b.

With the intake screen assembly 100, an internal flow modifier assembly 60, for example, internal flow modifiers as described in PCT Publication WO 2019/200208, serves to modify the high flow velocity region 54 such that the key flow velocity isosurface 56 is modified and essentially broken into lobes 62 as shown in FIG. 1c. While such an internal flow modifier assembly 60 can be utilized successfully to keep the key flow velocity isosurface 56 within the interior portion of the intake screen assembly 100, the manufacturing and installation of the internal flow modifier assembly 60 can be expensive, both in material and labor, as well as leaving certain void areas 64 that essentially mean the interior portion of the intake screen assembly 100 has been oversized.

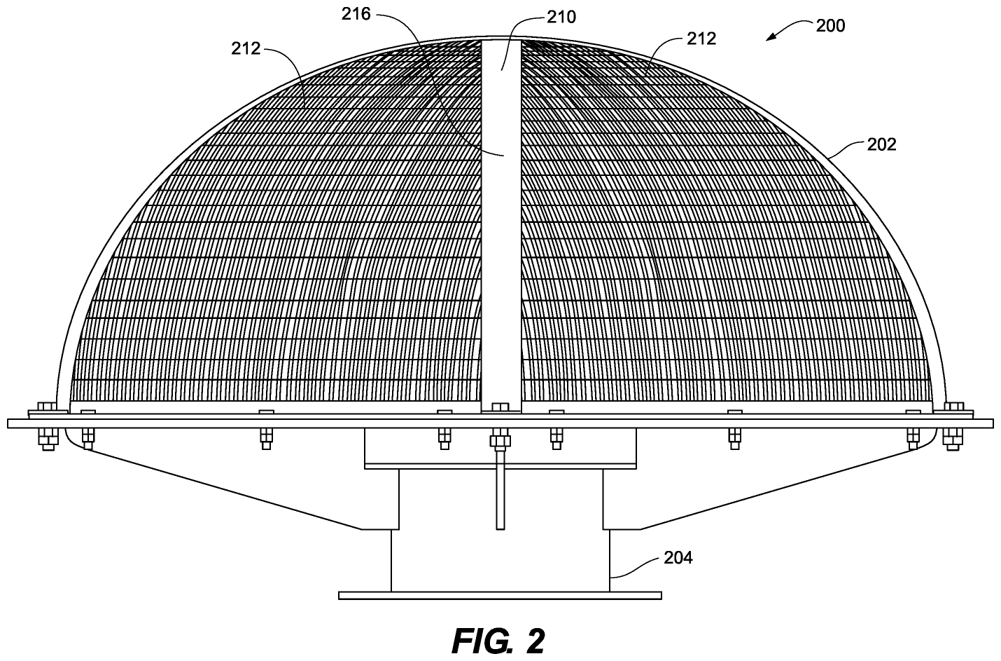

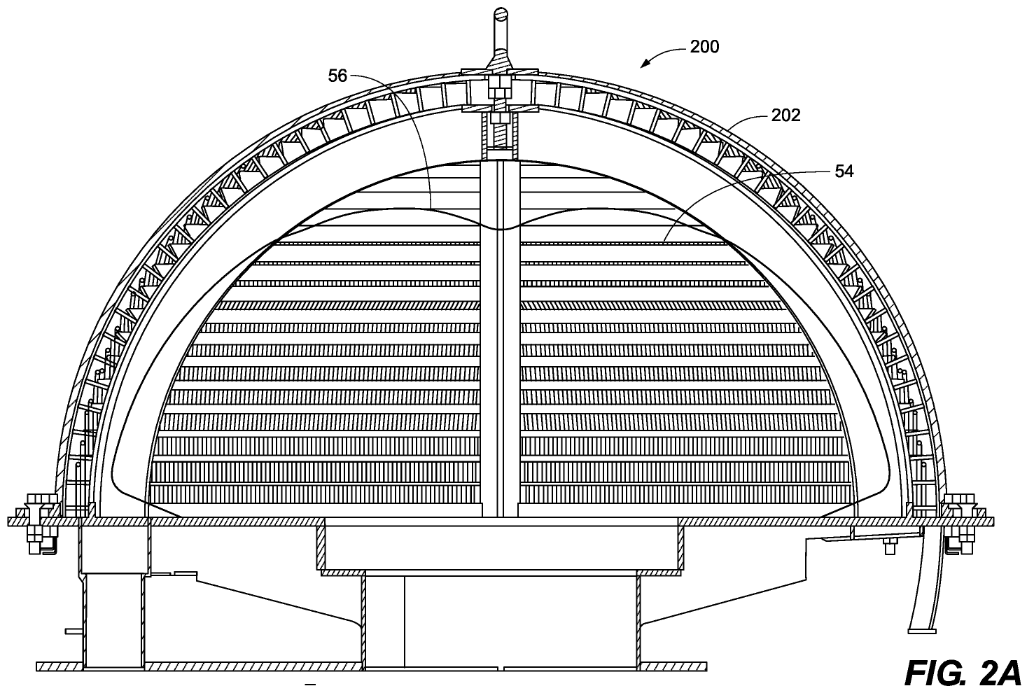

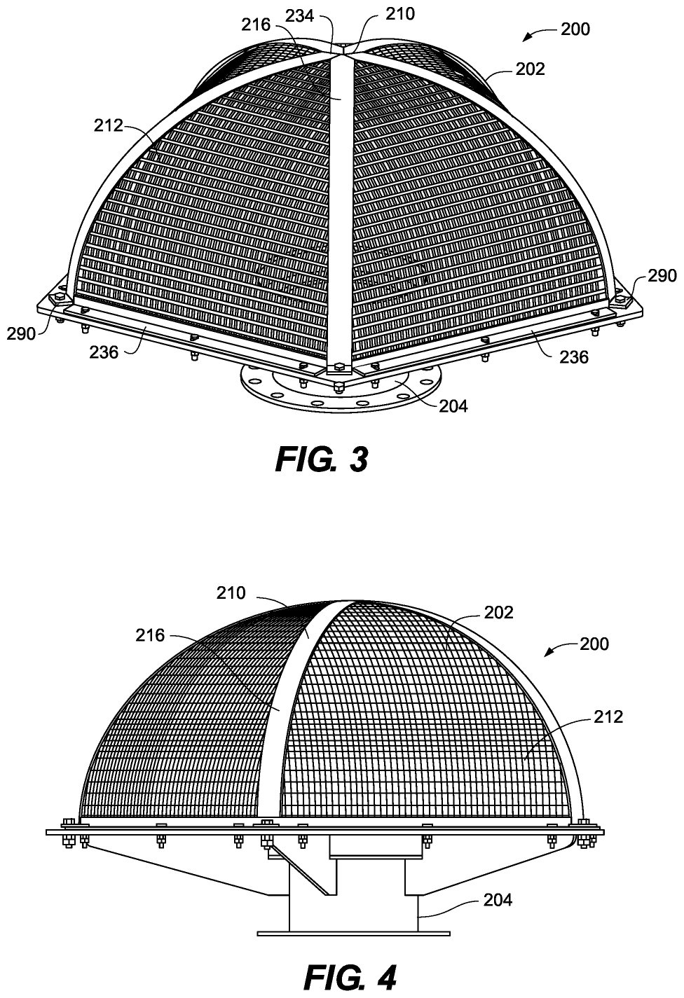

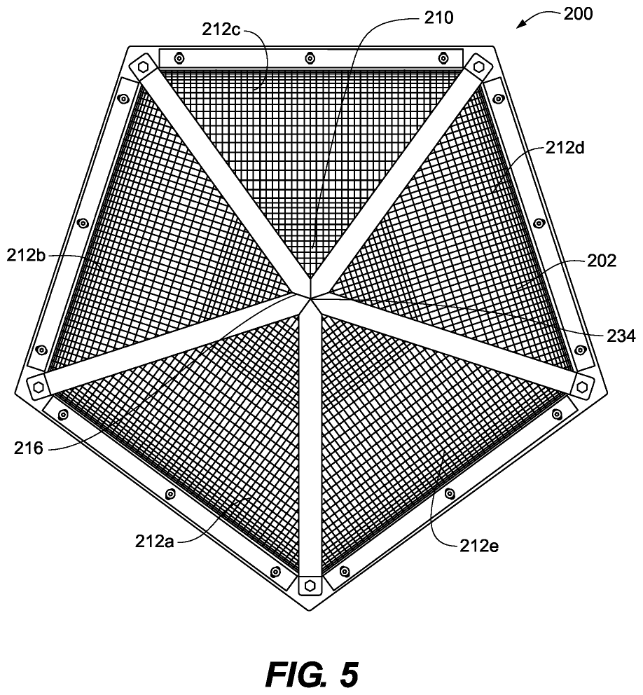

An intake screen assembly 200 according to an embodiment of the present invention is illustrated in FIGS. 2, 2a, 3, 4 and 5. Generally, intake screen assembly 200 will be fabricated of materials suitable for long term submersion in a body of water. Representative materials can include, for example, metals and metal alloys such as stainless steel, aluminum, copper, copper-nickel alloys and the like as well as polymeric materials such as, for example, polyvinyl chloride, propylene and the like. As illustrated, intake screen assembly 200 generally comprises a domed or hemispherical upper screen structure 202 that is operably coupled to a central intake structure 204. As shown in FIG. 2a, central intake structure 204 will be fluidly coupled to a pipe or tubing assembly allowing the intake screen assembly 200 to supply filtered water to a desired use location, for example, on a shoreline adjacent the body of water in which the intake screen assembly 200 has been submerged.

With reference to FIG. 2a, the use of a domed or hemispherical upper screen structure 202 encompasses the high flow velocity region 54 without requiring any internal flow modifier assembly 60. Even more specifically, the size of the domed or hemispherical upper screen structure can be sized to be just oversized with respect to the key flow velocity isosurface 56.

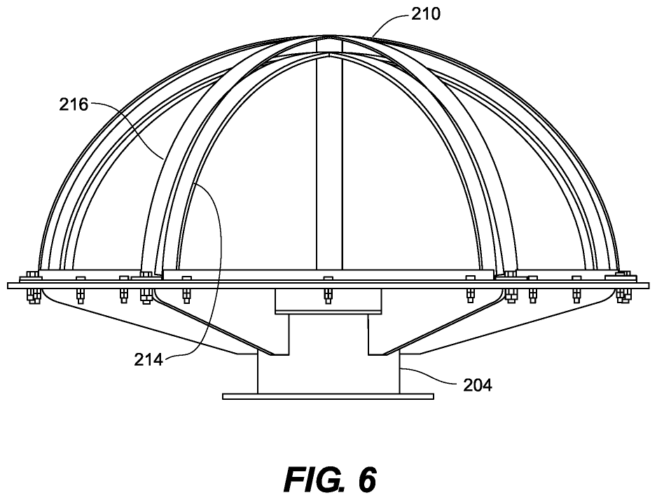

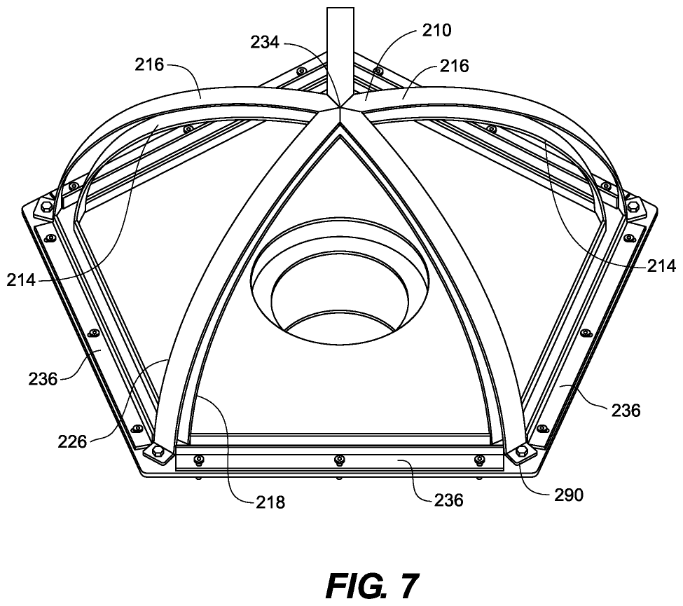

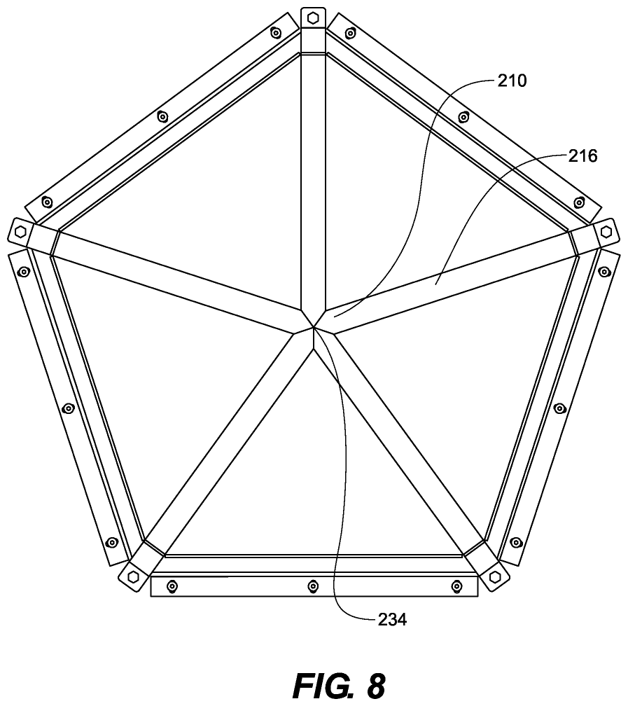

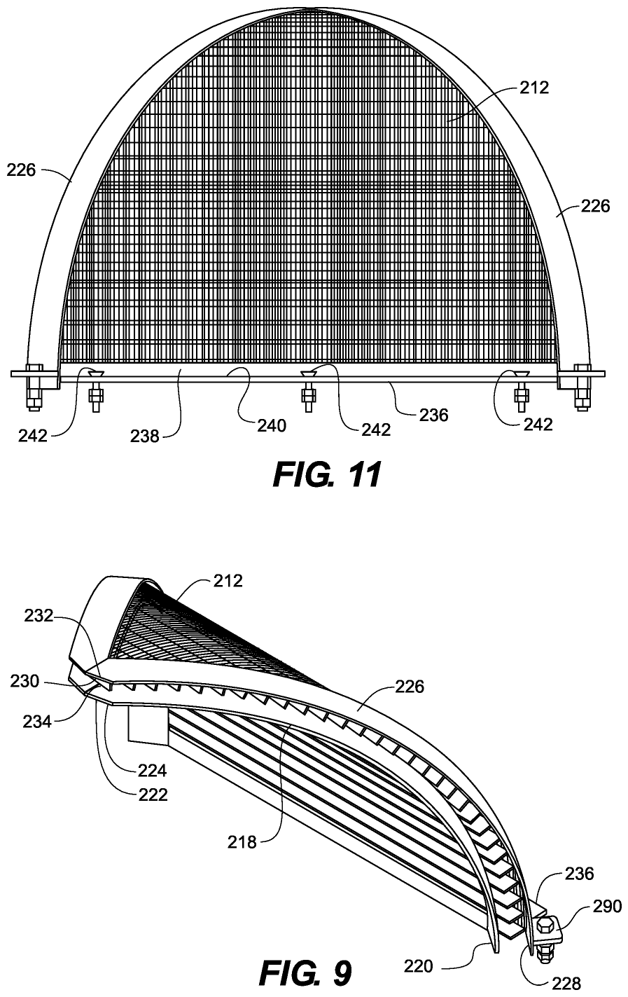

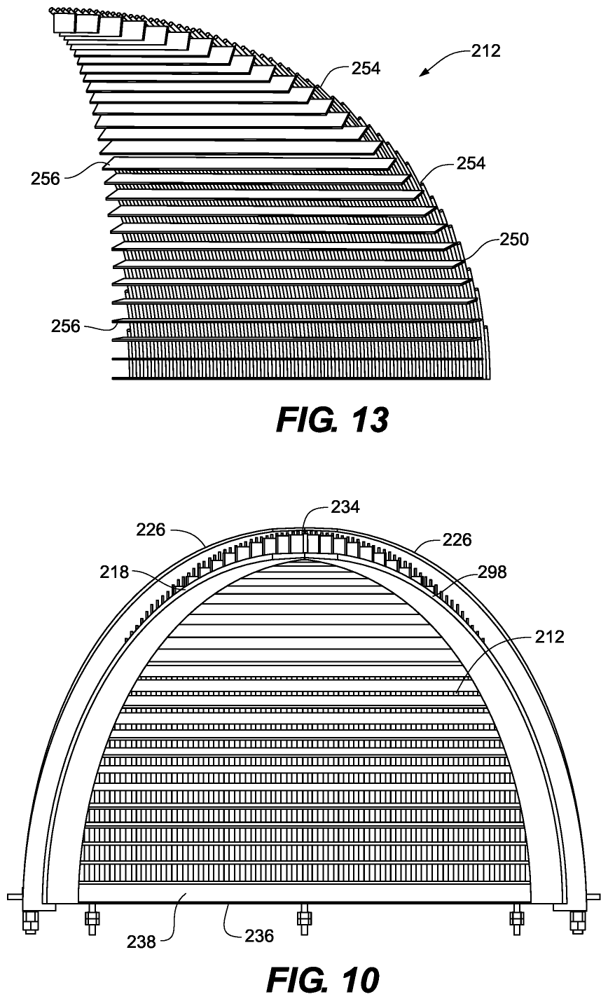

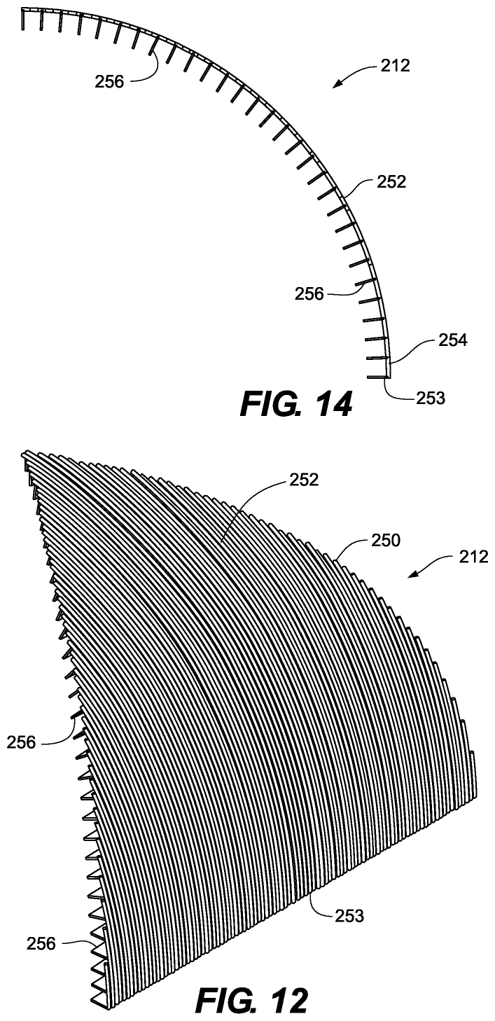

As seen in FIGS. 2, 3, 4 and 5, it can be seen that intake screen assembly 200 generally comprises five arcuate filter screens 212a, 212b, 212c, 212d and 212e though it will be understood (and shown in later embodiments) that the number of arcuate filter screens 212 can be varied depending upon desired flow performance and overall size of the intake screen assembly 200. Frame structure 210 generally comprises an interior frame 214 and an exterior frame 216 as best seen in FIGS. 6, 7 and 8. Referring to FIGS. 9, 10 and 11, interior frame 214 is defined by a plurality of interior frame members 218 having an interior flange end 220 and an interior hub end 222. Interior hub end 222 can include an interior angled end surface 224. Exterior frame 216 is defined by a plurality of exterior frame members 226 having an exterior flange end 228 and an exterior hub end 230. Exterior hub end 230 can include an exterior angled end surface 232. Generally, the interior frame members 218 and exterior frame members 226 are arranged such that adjacent interior angled end surfaces 224 and adjacent exterior angled end surfaces 232 define an upper hub 234. Frame structure 210 further comprises a plurality of angle members 236 defining a vertical surface 238 and a horizontal surface 240, wherein said horizontal surface 240 generally comprises a plurality of angle member apertures 242.

Each arcuate filter screen 212 generally defines an arcuate, approximately triangular shape 250. The arcuate filter screens 212 are originally formed in a flat configuration and then “rolled” or otherwise manipulated to define the desired arcuate configuration. Generally, each arcuate filter screen 212 has a screen surface 252 that is defined by a plurality of spaced apart wires 254 that are operably coupled to a plurality of support ribs or rods 256. Preferably, the spaced apart wires 254 can comprise shaped wire elements, for example, Vee-Wire® that defines an approximately triangular cross section. Generally, the spacing between adjacent spaced apart wires 254 defines a filter rating of the arcuate filter screen 212 and determines the size of particulates and debris that are prevented from passing through the screen surface 252. In one representative embodiment, the support ribs 256 can be arranged in a spaced apart, parallel arrangement upon which the spaced apart wires 254 are then arranged on top of the support ribs 256 so as to reside perpendicular to the support rods 256. The spaced apart wires 254 are coupled to the support rods 256, for example, with an appropriate welding operation to define the screen surface 252.

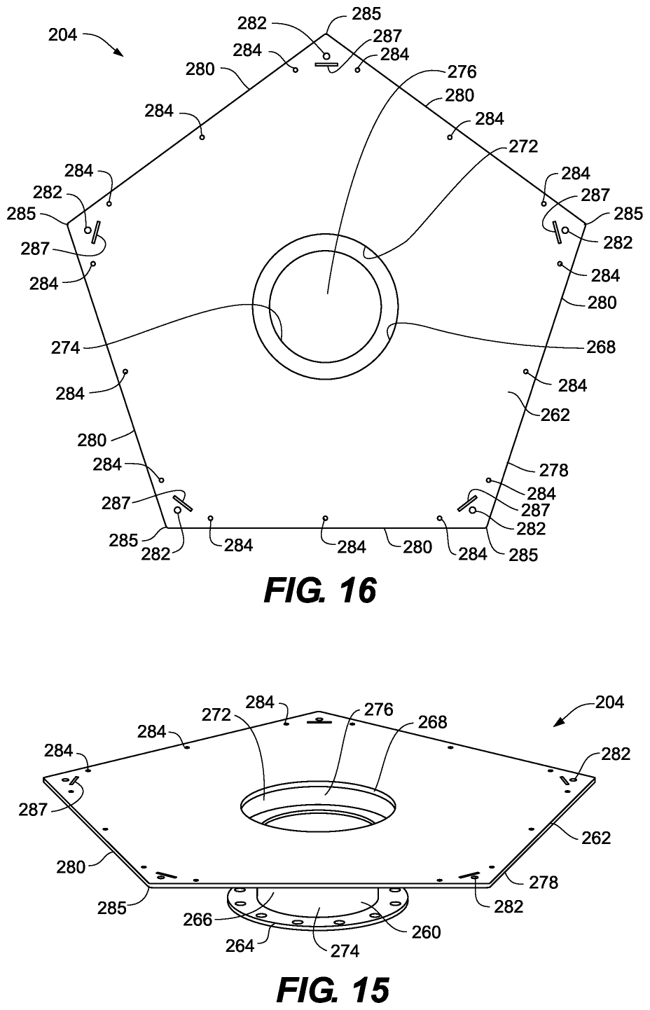

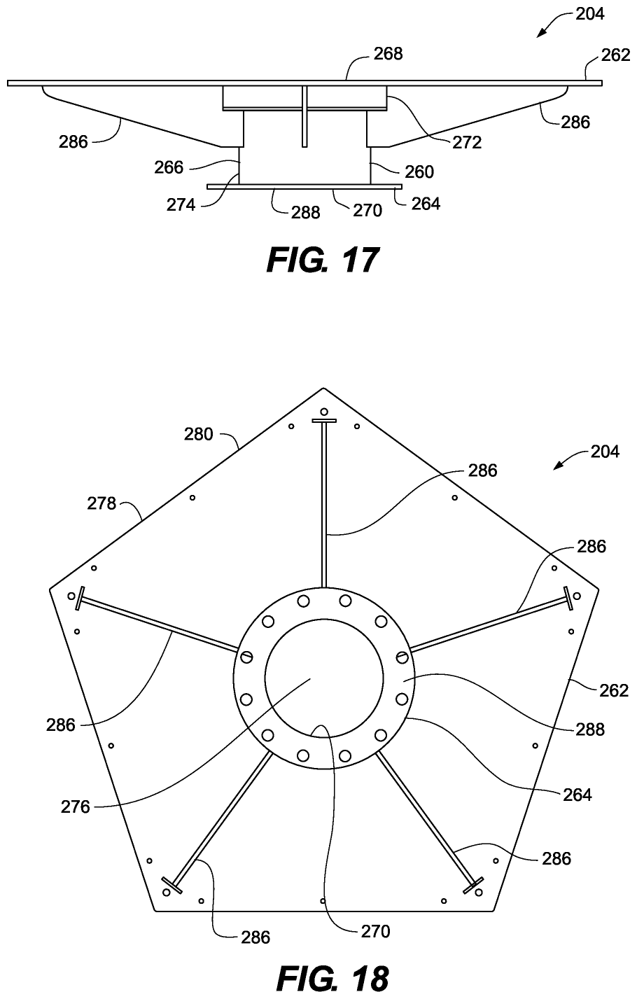

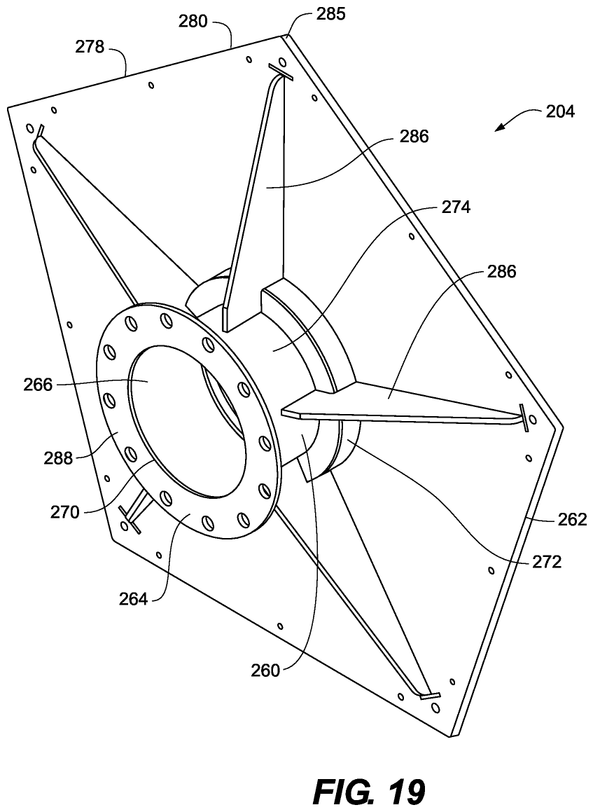

Referring to FIGS. 15, 16, 17, 18 and 19, central intake structure 204 generally comprises an intake pipe 260, an upper coupling flange 262 and a lower coupling flange 264. Intake pipe 260 generally comprises a hollow pipe body 266 extending between a pipe inlet 268 and a pipe outlet 270. In some embodiments, hollow pipe body 266 can comprise an upper pipe portion 272 and a lower pipe portion 274, with said upper pipe portion 272 having an increased diameter as compared to the lower pipe portion 274. Upper coupling flange 262 is fluidly coupled to the hollow pipe body 266 either at or in proximity to the pipe inlet 268 such that a central flow aperture 276 is essentially fluid-tight to the upper pipe portion 272 to prevent any fluid bypass of the domed or hemispherical upper screen structure 202. Upper coupling flange 262 generally comprises a flange perimeter 278 defined by a plurality of flange sides 280, wherein the number of flange sides 280 corresponds to the number of arcuate filter screens 212 used in constructing the domed or hemispherical upper screen structure 202. The flange perimeter 278 generally defines a 3600 perimeter surrounding the central flow aperture 276. Generally, each flange side 280 includes a pair of frame mounting apertures 282 and a plurality of screen retention apertures 284, wherein adjacent flange sides 280 intersect at side junctions 285. Each side junction 285 includes one frame mounting aperture 282 and a mounting slot 287. Central intake structure 204 can further comprise a plurality of support brackets 286 operably connecting the hollow pipe body 266 and the upper coupling flange 262 to reinforce and provide structural strength to the intake screen assembly 200. Lower coupling flange 264 is operably connected to the hollow pipe body 266 and generally provides a connecting surface 288 for operably connecting the intake screen assembly 200 with a pipe or tubing run that delivers water from the interior of the intake screen assembly 200 to a point of use.

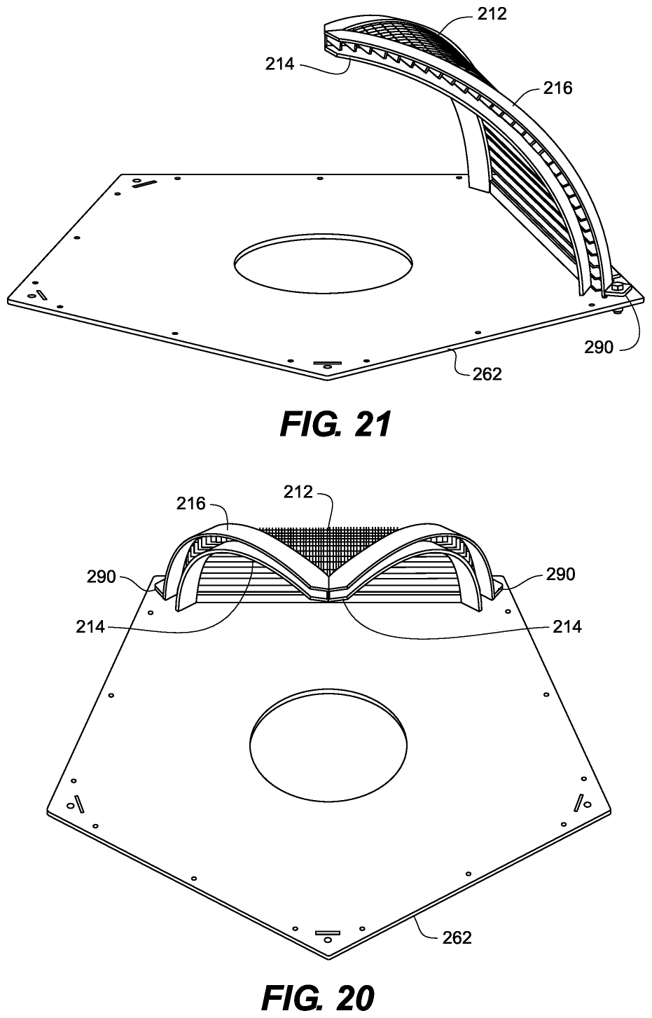

Generally, the intake screen assembly 200 can be assembled by operably coupling the interior frame 214 to the central intake structure 204 as shown representatively in FIGS. 20 and 21. Specifically, the interior frame 214 is sequentially assembled by placing the interior frame members 218 such that the interior flange ends 220 are positioned proximate the corresponding side junction 285. Though not shown, it will be understood that the upper coupling flange 262 can include a second mounting slot located inward from each mounting slot 287 in which the interior flange ends 220 can be inserted and retained during assembly. With the interior flange ends 220 positioned at the side junctions 285, the interior hub ends 222 can be brought into proximity to start to define the upper hub 234. At this point, the interior hub ends 222 can be welded to together and the interior flange ends 220 can be welded to the upper coupling flange 262 such that the interior frame 214 is positively coupled to the central intake structure 204.

With the central intake structure 214 assembled and coupled to the central intake structure 204, the arcuate filter screens 212 can be put into position between adjacent interior frame members 218. Generally, the arcuate filter screens are arranged such that the screen surface 252 faces outward from the central intake structure 204.

The arcuate filter screens 212 are retained in position by assembling the exterior frame 216 and capturing the arcuate filter screens 212 between the interior frame 214 and the exterior frame 216. Generally, the exterior frame members 226 are positioned such that the exterior flange ends 228 are retained in the corresponding mounting slot 287 at each side junction 285 and the exterior hub ends 230 are brought into proximity and contacted with each other to finish defining the upper hub 234. Using a flat member 290, each exterior flange end 228 can be coupled to the corresponding frame mounting aperture 282 using a suitable connector. The angle members 236 can then be positioned along each flange side 280 such that the angle member apertures 242 are aligned with the corresponding screen retention apertures 284 and the angle members 236 can be coupled to the upper coupling flange 262 with the vertical surface 238 positioned to retain bottom edge 253 of the arcuate screen filters 212. With the exterior frame 216 fully assembled, the arcuate screen filters 212 are retainably captured between the interior frame 214 and the exterior frame 216. While not part of the normal assembly process, the process by which the arcuate screen filters 212 are retained by the exterior frame 216 provides an opportunity to replace damaged or worn arcuate screen filters 212 by uncoupling two or more of the exterior frame members 226 and repeating the assembly process of the exterior frame 216 with a new arcuate screen filter 212.

Once assembled, the intake screen assembly 200 can be transported to the desired body of water, submerged and attached to a pipe or tubing assembly for transporting filtered water to a point of use. Generally, water will enter the domed or hemispherical upper screen structure 202 by passing through the screen surface 252, whereby particulates and debris larger than the spacing between adjacent spaced apart wires 254 are prevented from entering the domed or hemispherical upper screen structure 202. Water that has passed through the screen surface 252 then travels through the central flow aperture 276 and into the pipe inlet 268 of the intake pipe 260. Water flows through the hollow pipe body 266 and out the pipe outlet 270. From there, the water flows through the pipe or tubing assembly and to the point of use.

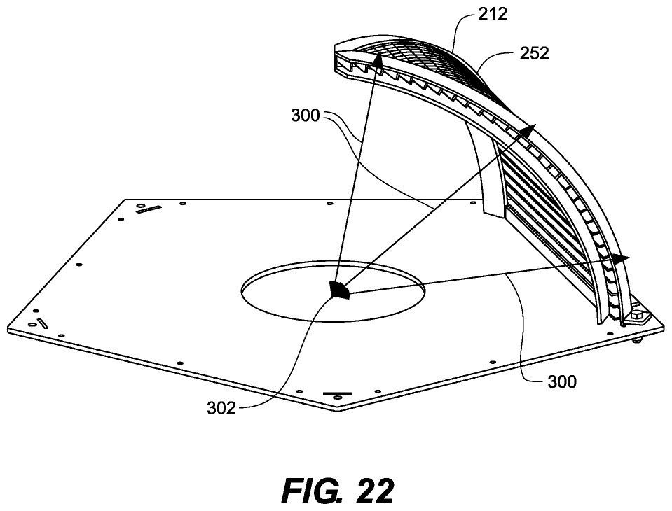

Domed or hemispherical upper screen structure 202 provides dimensional advantages that eliminate the need for complicated and expensive internal flow modifier assemblies as is often necessary in conventional screen intakes. As seen in FIG. 22, a screen radius 300 from a center point 302 of the pipe inlet 268 is generally constant at every point of each arcuate screen filter 212. As such, pressure drops and flow velocities across the domed or hemispherical upper screen structure 202 are approximately equal along the screen surface 252 of each arcuate screen filter 212. This design is especially advantageous in installations where a flow velocity through each screen filter 212 is restricted so as to not exceed a specified velocity, for example, not to exceed 0.5 ft/sec as is commonly specified to prevent entrapping and harming aquatic life.

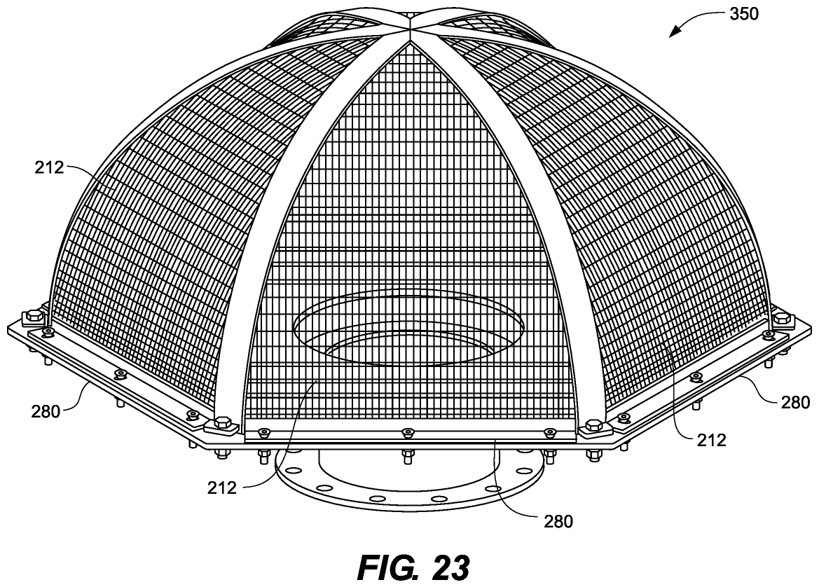

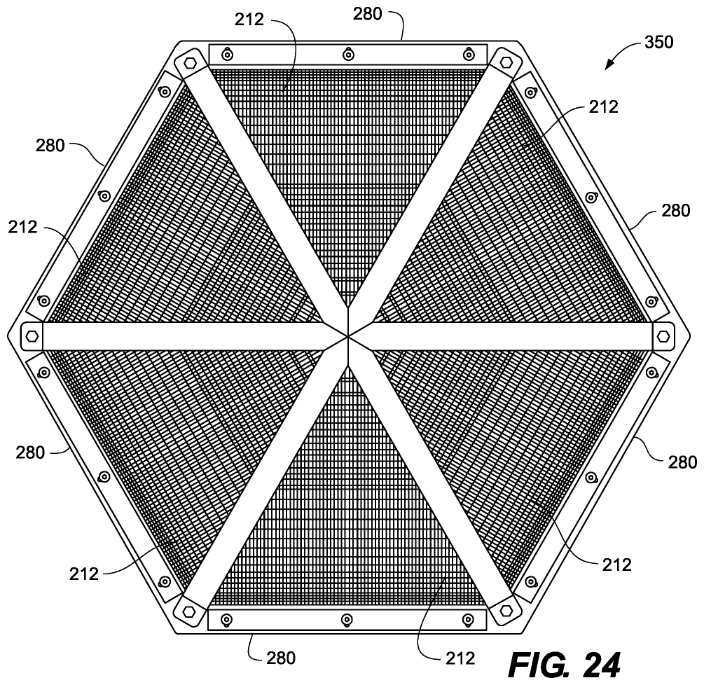

As discussed previously, an intake screen assembly of the present invention can have any number of arcuate filter screens and upper coupling flange sides. For example, FIGS. 23 and 24 illustrate an embodiment of an intake screen assembly 350 having six arcuate filter screens 212 and six flange sides 280, with the assembly process being otherwise the same as that previously described with respect to intake screen assembly 200. In similar fashion, intake screen assemblies having a domed or hemispherical upper screen structure can be easily fashioned having four, eight, nine, ten or even more arcuate filter screens and flange sides based upon desired filtering capacities and user preferences.

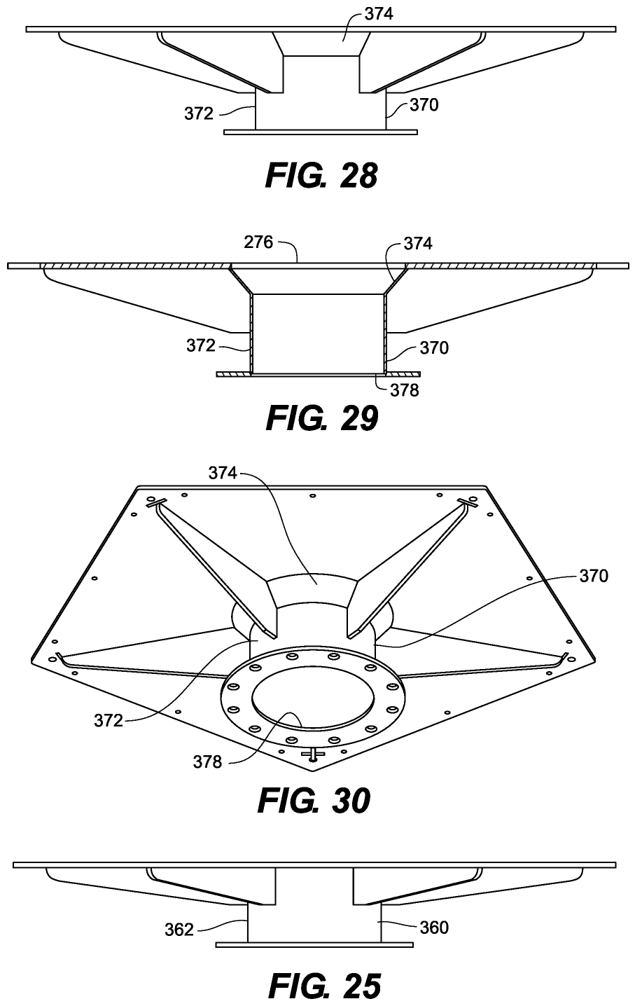

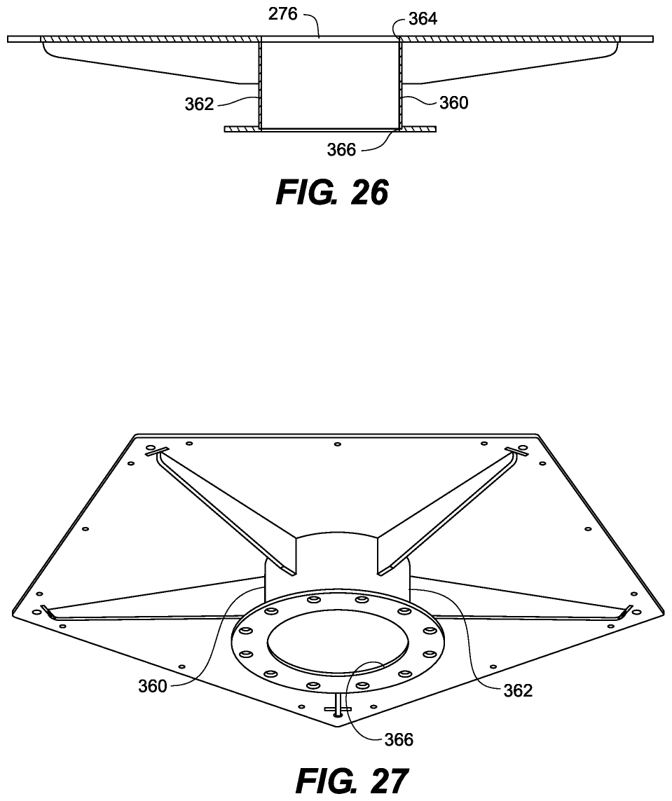

In some embodiments, central intake structure 204 can comprise alternative arrangements for coupling the central flow aperture 276 to the intake pipe 260. With reference to FIGS. 25, 26 and 27, an alternative embodiment of an intake pipe 360 can comprise a hollow pipe body 362 having a single common diameter from a pipe inlet 364 to a pipe outlet 366 such that the diameter of the central flow aperture 276 equals the diameter of the intake pipe 360. With reference to FIGS. 28, 29 and 30, another alternative embodiment of an intake pipe 370 can comprise a hollow tube body 372 with a tapered, conical portion 374 such that the diameter of the central flow aperture 276 is larger than a diameter at pipe outlet 378, with said tapered conical portion 374 seamlessly interconnecting transitioning between the two different diameters. Generally, the configuration of the intake pipe and its connection to the central flow aperture 276 can be tailored to provide desired flow characteristics.

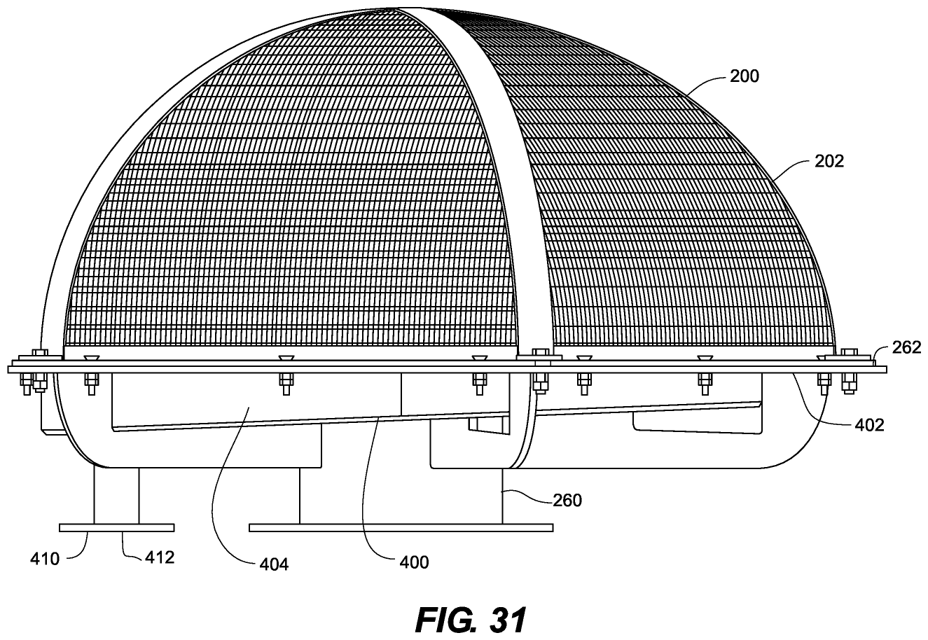

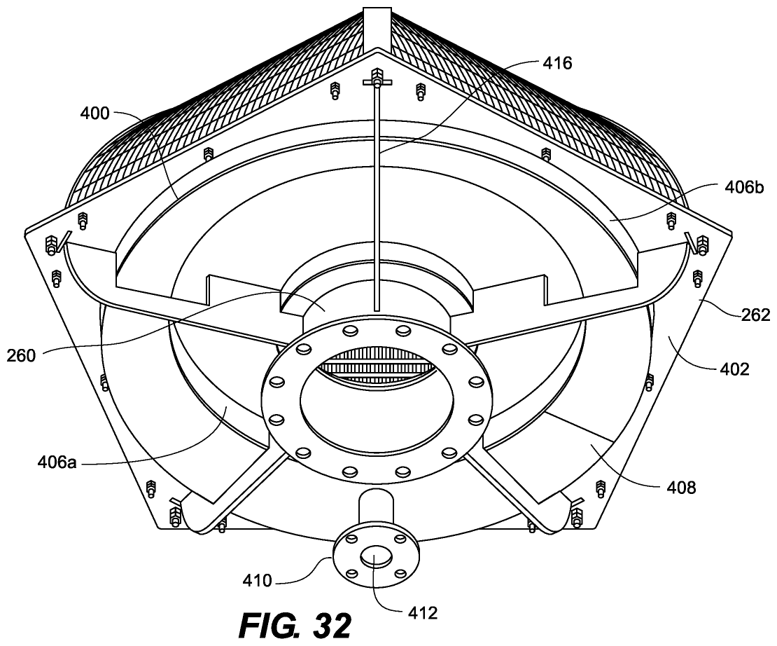

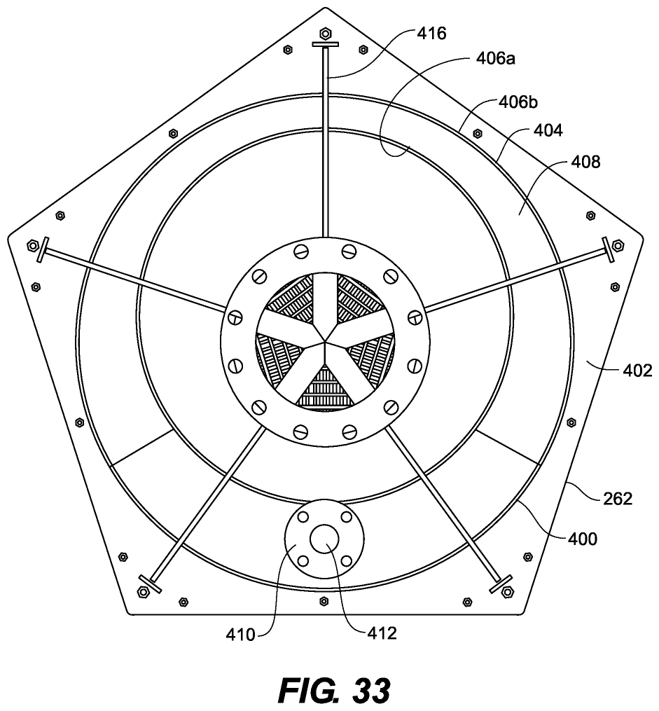

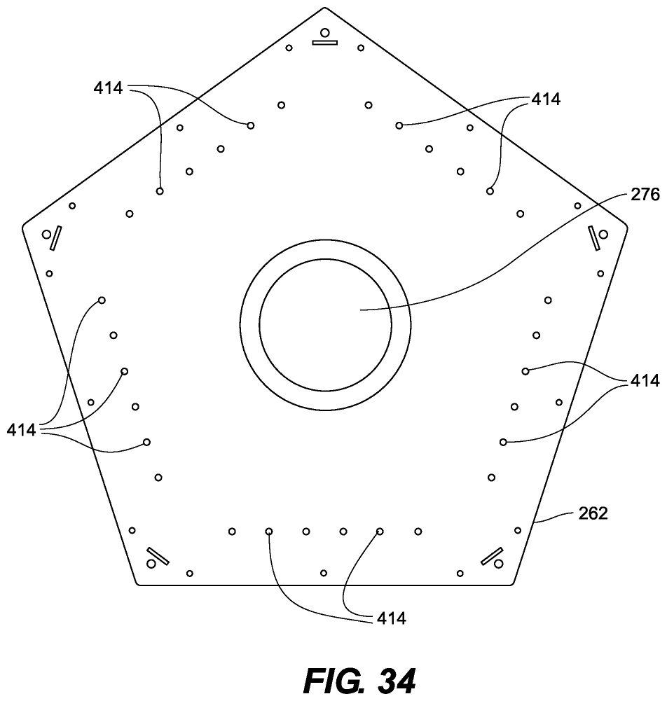

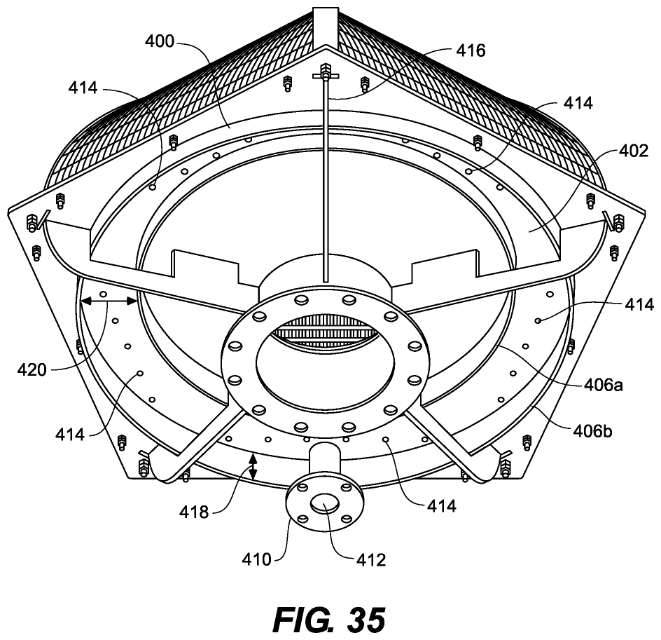

As discussed previously, the dimensional advantages provided by the use of domed or hemispherical upper screen structure 202 allows for flow velocities to be essentially equal as there is no difference in pressure drop and thus, no expensive internal flow modifiers or structures are necessary to otherwise manage flow characteristics within the intake screen assembly 200. As such, it would be further advantageous to have an air burst system 400 which can be used with intake screen assembly 200 that similarly lacks structure within the domed or hemispherical upper screen structure 202 that might otherwise negatively impact flow characteristics and add additional cost and complexity. Referring now to FIGS. 31, 32, 33, 34 and 35, the air burst system 400 can be operably coupled to a bottom flange surface 402 of the upper coupling flange 262. Generally, air burst system 400 can comprise a circular backwash duct 404 defined by the bottom flange surface 402, a pair of side walls 406a, 406b and a bottom duct wall 408, wherein the circular backwash duct 404 is arranged to surround the intake pipe 260 and the central flow aperture 276. The bottom duct wall 408 can include an air burst inlet pipe 410 defining an air inlet 412. Bottom flange surface 402 can include a plurality of air burst apertures 414 that extend through the upper coupling flange 262 and are arranged around the central flow aperture 276 to as to be in communication with the circular backwash duct 404.

Generally, air burst system 400 allows pressurized air to be introduced into the domed or hemispherical upper screen structure 202 such that any particulates or debris which has become entrapped against the screen surface 252 of the arcuate filter screens 212 can be dislodged by directing air in a direction opposite to normal water flow through the screen surface 252. Generally, pressurized air can be provided from a remote compressor and supplied through a tubing or piping system that is connected to the air burst inlet pipe 410. The pressurized air enters the circular backwash duct 404 and is then directed through the air burst apertures 414 such that the pressurized air travels into the domed or hemispherical upper screen structure 202 and proceeds through the screen surface 252 of the arcuate filter screens 212, whereby any entrained particulates or debris is blasted from the screen surface 252. In order to ensure that air is evenly distributed through the air burst apertures 414 and consequently, within the domed or hemispherical upper screen structure 202, the cross-section of the circular backwash duct 404 can be varied such that the cross-section is reduced at an opposed duct location 416 that is located opposite the air burst inlet pipe 410. The cross-section can be reduced by one or both of tapering a wall height 418 or a duct width 420 as the circular backwash duct 404 transitions between the air burst inlet pipe 410 and the opposed duct location 416.

While air burst system 400 is shown as being defined by the bottom flange surface 402, a pair of side walls 406a, 406b and a bottom duct wall 408 in FIGS. 31, 32, 33 and 35, it will be understood that the cross-sectional appearance of the circular backwash duct 404 can assume a variety of configurations while still providing for beneficial backwashing of the domed or hemispherical upper screen structure 202. For example, the circular backwash duct 404 could have an arcuate or hemispherical cross-section, for example, resembling a portion of a pipe or tube. Alternatively, the circular backwash duct 404 could possess a cross-section defined by multiple facets or surfaces such that the cross-section resembles a triangle or a portion of hexagon, octagon or the like. In yet another embodiment, a single large air chamber could surround the intake pipe 260 and the central flow aperture 276 such that the air chamber has a diameter extending beyond the air burst apertures 414 or alternatively, includes a plurality of ducts that extend from the air chamber to each individual air burst aperture 414. Regardless of the particular configuration of the air burst system 400, the defining characteristic is that no portion of the air burst system 400 physically resides within the interior of the domed or hemispherical upper screen structure 202 and instead is mounted to the bottom flange surface 402. In this way, the air burst system 400 does not impact the flow characteristics of the intake screen assembly 200 during normal operation.

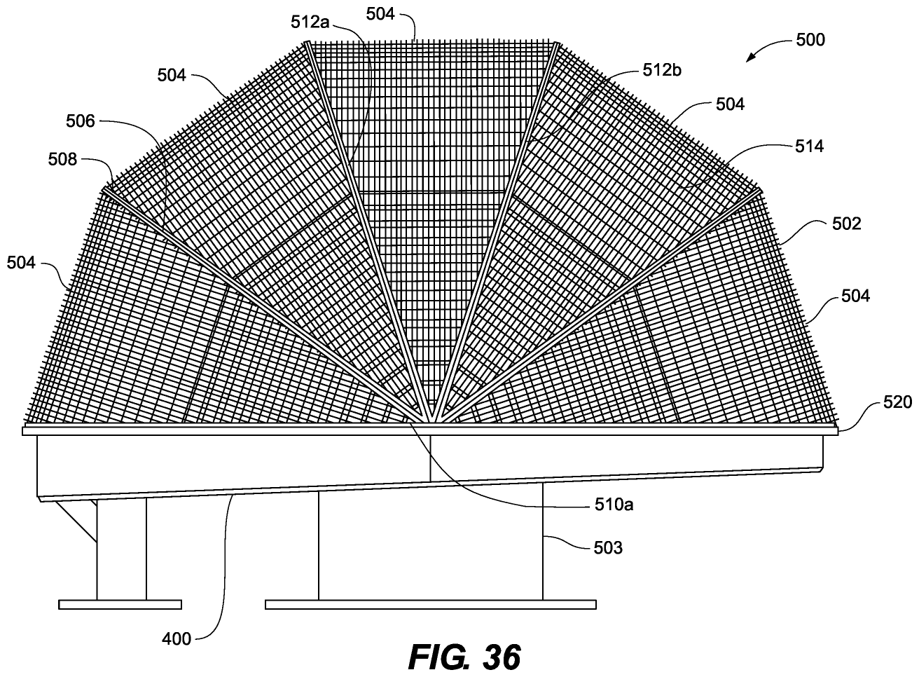

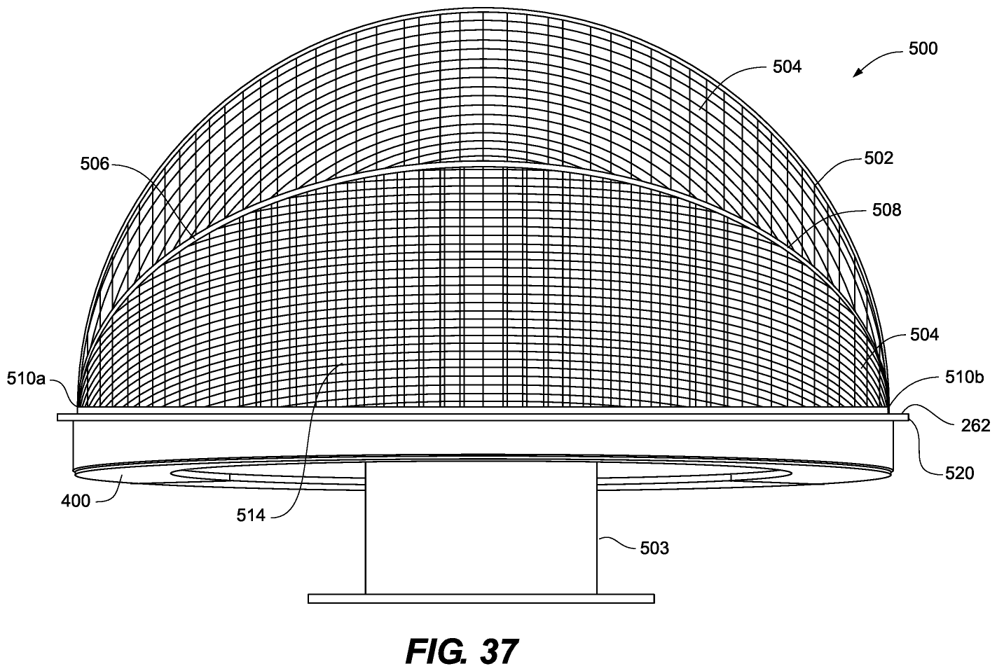

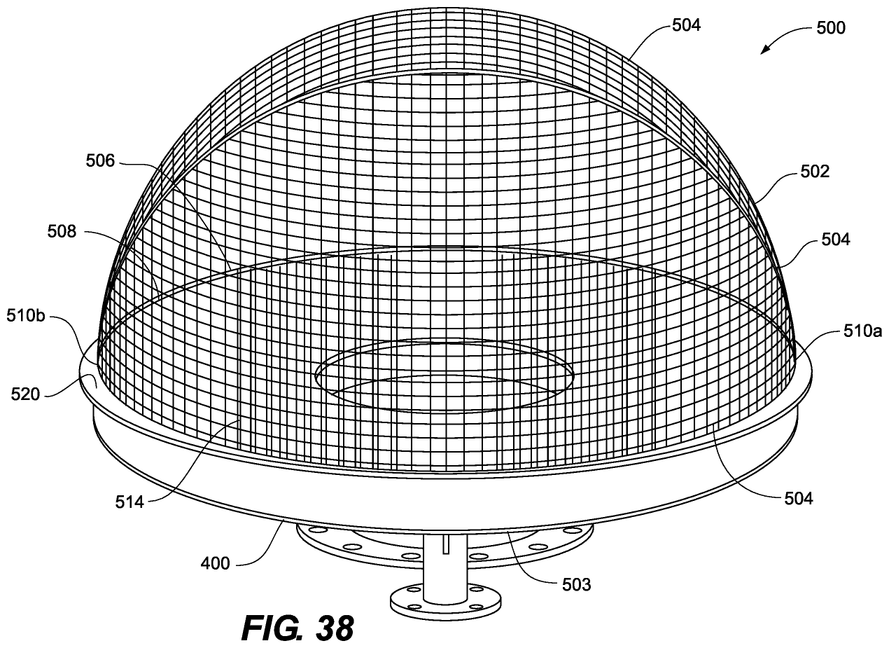

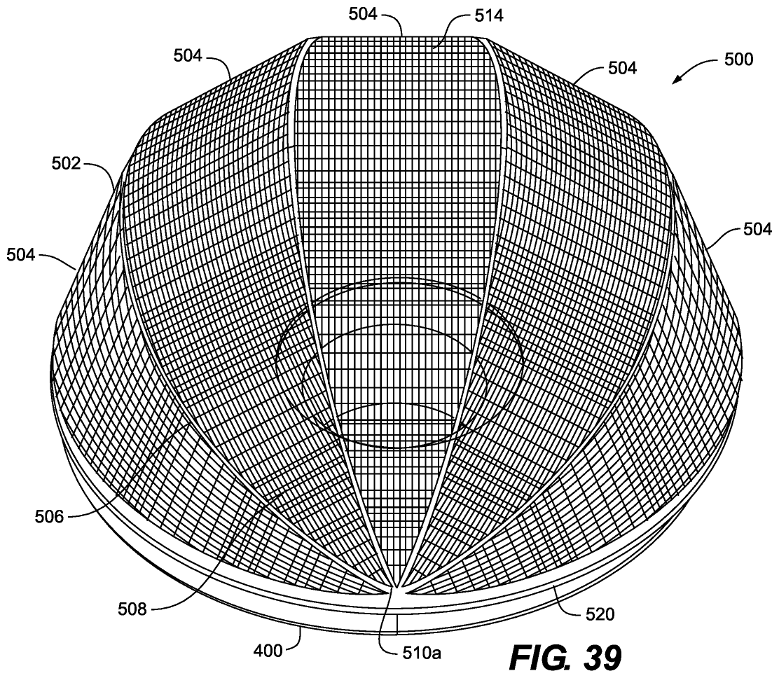

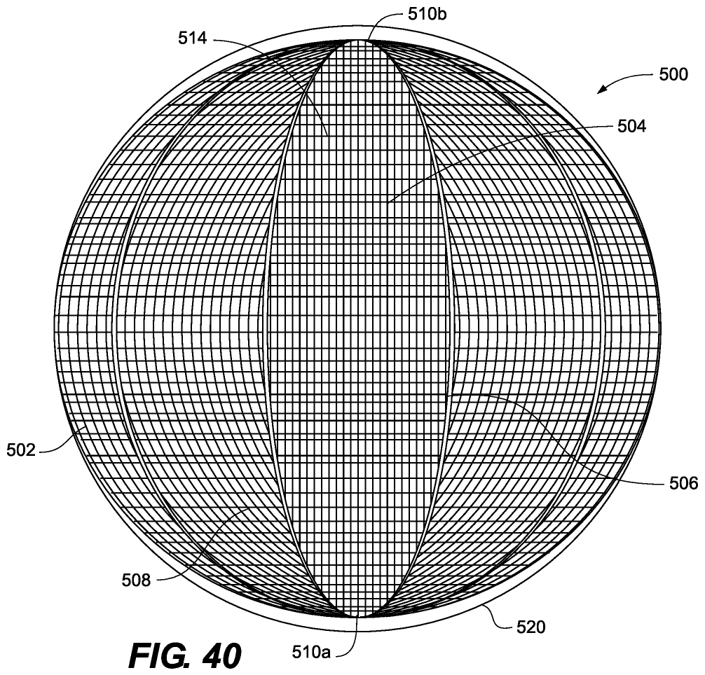

Referring now to FIGS. 36, 37, 38, 39 and 40, another embodiment of the intake screen assembly 200 can comprise an intake screen assembly 500 having a domed or hemispherical upper screen structure 502 that is operably coupled to a central intake structure 503. Domed or hemispherical upper screen structure 502 is generally defined by a plurality of arcuate filter screens 504 having a pointed-elliptical or mandorla shaped perimeter 506. Generally, each arcuate filter screen 504 has a frame 508 defined by a pair of pointed ends 510a, 510b and a pair of arcuate sides 512a, 512b defining the perimeter 506. Generally, each arcuate filter screen 504 includes a screen surface 514 between arcuate sides 512a, 512b. Generally, screen surface 514 can comprise a plurality of support rods mounted between the arcuate sides 512a, 512b upon which a plurality of parallel wires such as, for example, Vee-wire® are mounted so as to define slots through which water can flow and particulates and debris can be prevented from passing through.

Central intake structure 503 can substantially resemble the central intake structure 204 with the exception being that a flange perimeter 520 generally comprises arcuate or rounded perimeter shape as opposed to defining individual flange sides 280. Generally, the arcuate or rounded perimeter shape 520 is necessary to properly couple the appropriate arcuate sides 512a, 512b of the arcuate filter screens 504 at each end of the domed or hemispherical screen structure 502. Flange perimeter 520 is similar to flange perimeter 278 in that a 3600 perimeter is still defined around the central flow aperture 276. With the end filter screens 504 operably coupled to the upper coupling flange 262, either via welding or using conventional fasteners, the remaining filter screens 504 can be placed into their proper position and the arcuate sides 512a, 512b between adjacent filter screens 504 can be similarly connected to define the domed or hemispherical upper screen structure 502. Once assembled, the domed or hemispherical upper screen structure 502 functions in a similar manner and provides the same benefits as previously described with respect to the domed or hemispherical upper screen structure 202 including the use of air burst system 400. While the individual arcuate filter screens 504 have been described such that each comprises an individual frame 508, it will be understood that the domed or hemispherical upper screen structure 502 could be constructed in a manner similar to that previously described with respect to the domed or hemispherical upper screen structure 202, for example, the use of a frame structure including interior and exterior frames that cooperatively retain the individual filter screens. Similarly, hemispherical upper screen structure 202 can be constructed using a frame structure similar to the style utilized in the domed or hemispherical upper screen structure 502 and avoiding the need for separate interior and exterior frames 214, 216, wherein each frame structure is simply attached via welding or with appropriate fasteners to the upper coupling flange 262.

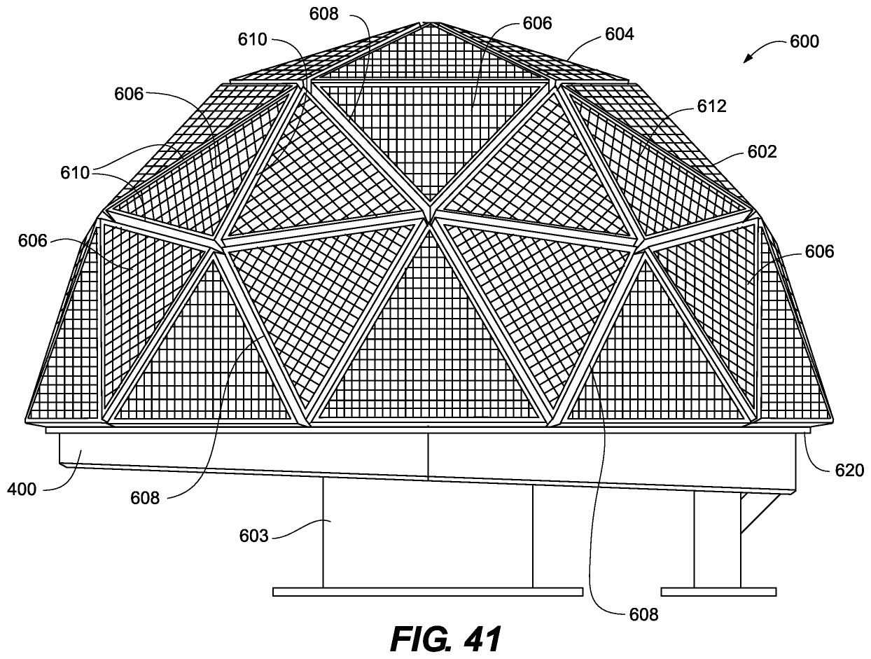

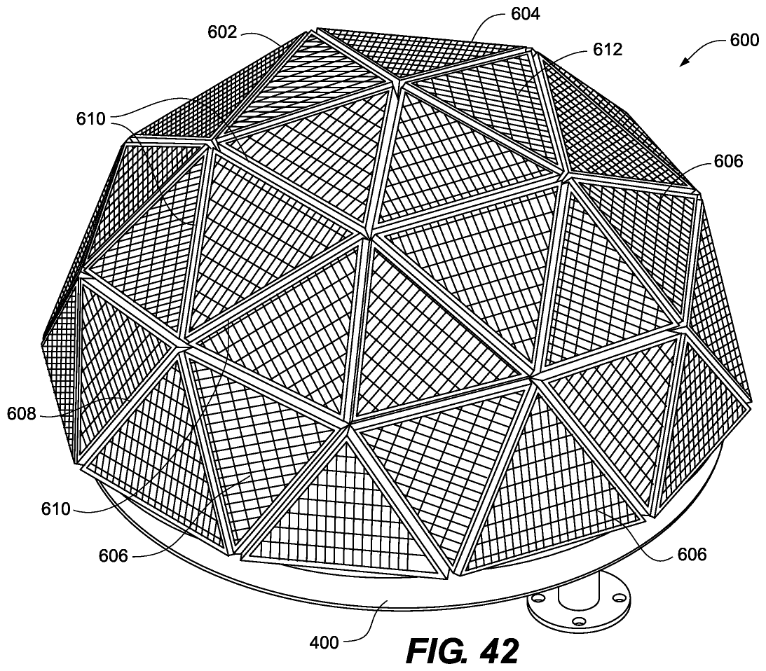

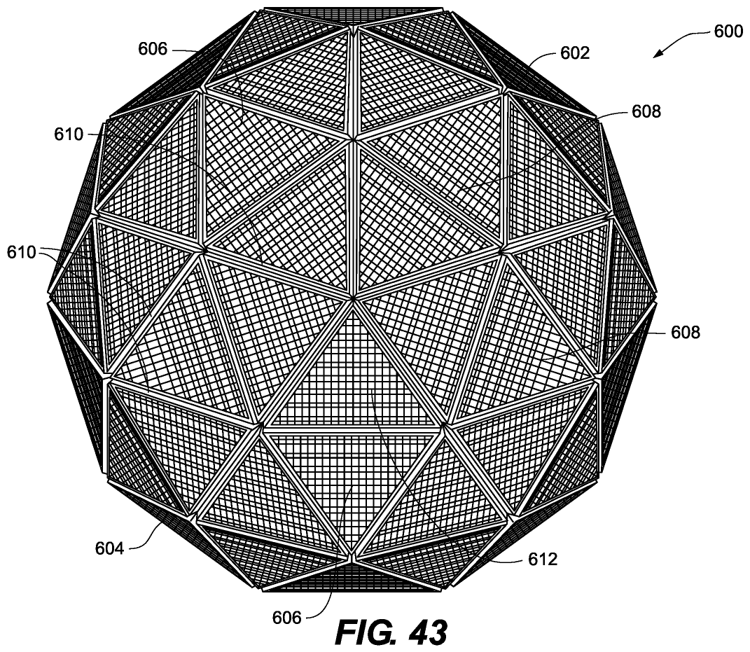

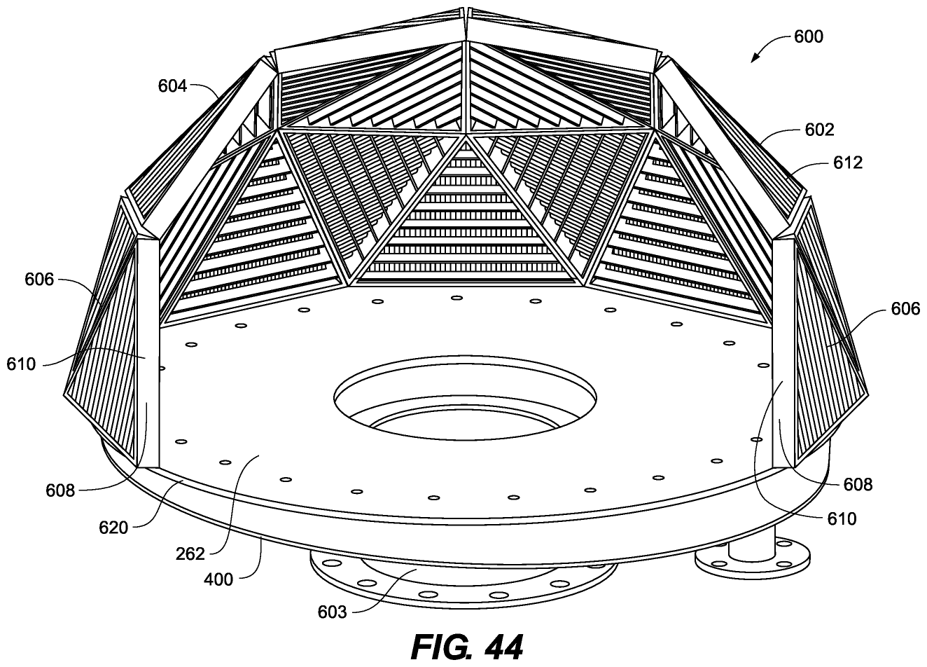

Referring now to FIGS. 41, 42, 43 and 44, another embodiment of the intake screen assembly 200 can comprise an intake screen assembly 600 having a dome or hemispherical upper screen structure 602 that is operably coupled to a central intake structure 603. Domed or hemispherical upper screen structure 602 can generally define a hemispherical polyhedron, for example, geodesic dome 604 that can be defined by a plurality of individual filter screens 606 that have a triangular frame 608. In alternative embodiments, the hemispherical polyhedron can comprise a dodecahedron dome formed of individual filter screens with pentagonal frames. The polygonal or triangular frame 608 each comprise a plurality of side members 610. Each filter screen 606 can define a screen surface 612 formed by mounting a plurality of parallel wires, such as, for example, Vee-Wire® on top of a plurality of support rods that extend between the side members 610. The individual filter screens 606 are operably coupled together with adjacent side members 610 being connected to define the geodesic dome 604.

Central intake structure 603 can substantially resemble the central intake structure 503 and defines an arcuate or rounded perimeter shape 620 to which the geodesic dome 604 is mounted. The geodesic dome 604 is coupled to the upper coupling flange 262 by welding or using conventional fasteners to join the bottom most side members 610 to the upper coupling flange 262. Once assembled, the domed or hemispherical upper screen structure 602 functions in a similar manner and provides the same benefits as previously described with respect to the domed or hemispherical upper screen structures 202 and 502 including the use of air burst system 400. While the individual arcuate filter screens 606 have been described such that each comprises an individual frame 608, it will be understood that the domed or hemispherical upper screen structure 602 could be constructed in a manner similar to that previously described with respect to the domed or hemispherical upper screen structure 202, for example, the use of a frame structure including interior and exterior frames that cooperatively retain the individual filter screens.

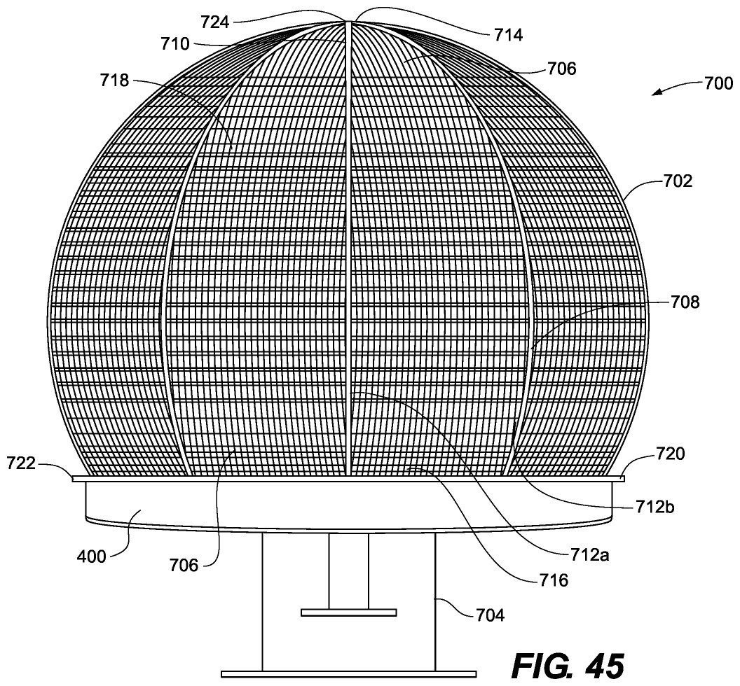

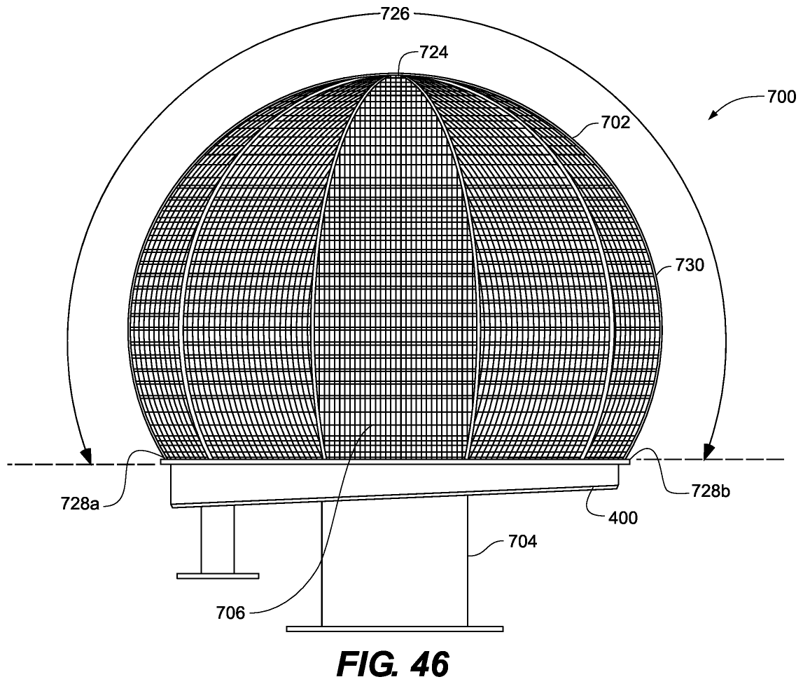

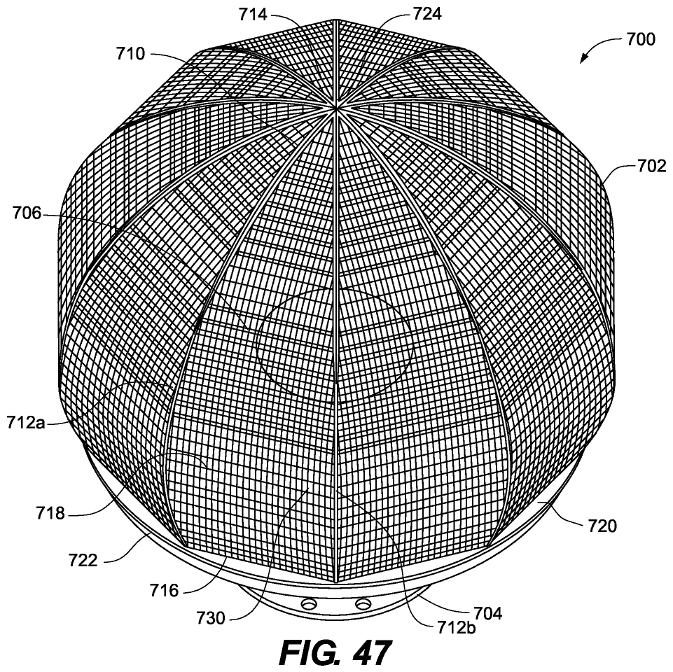

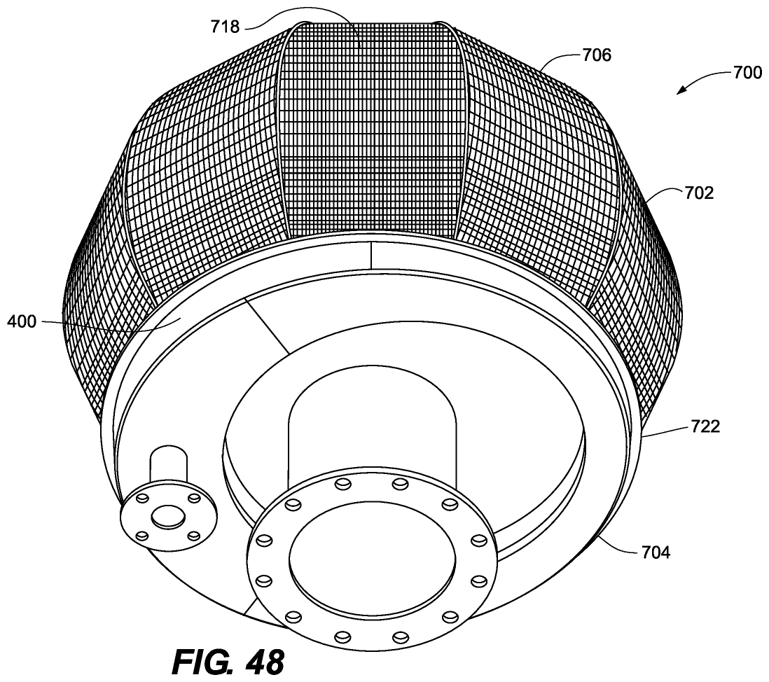

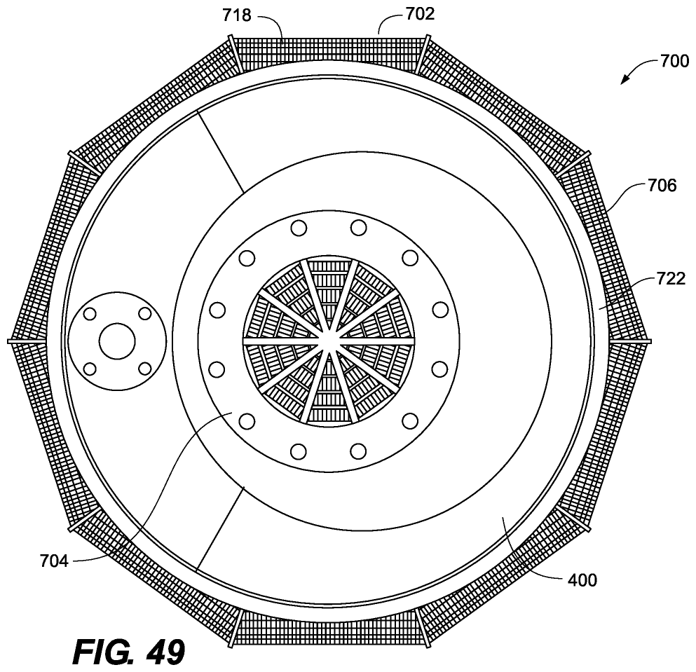

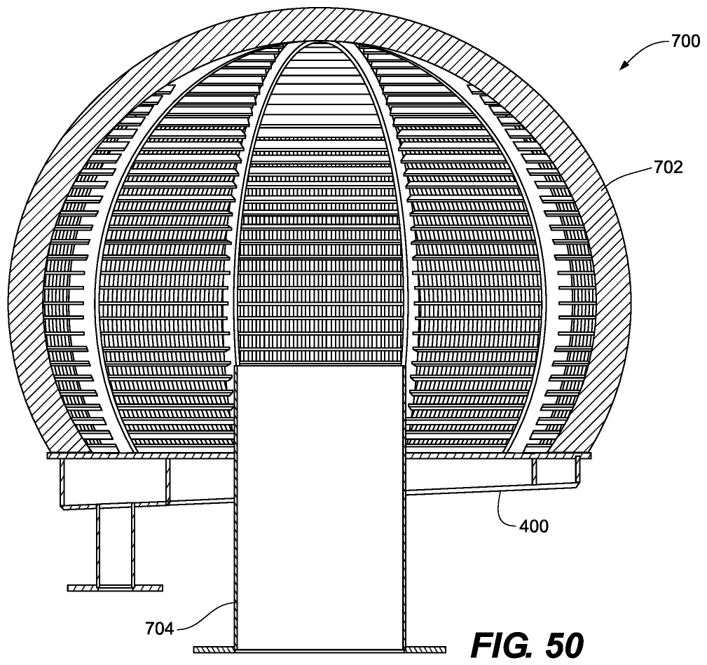

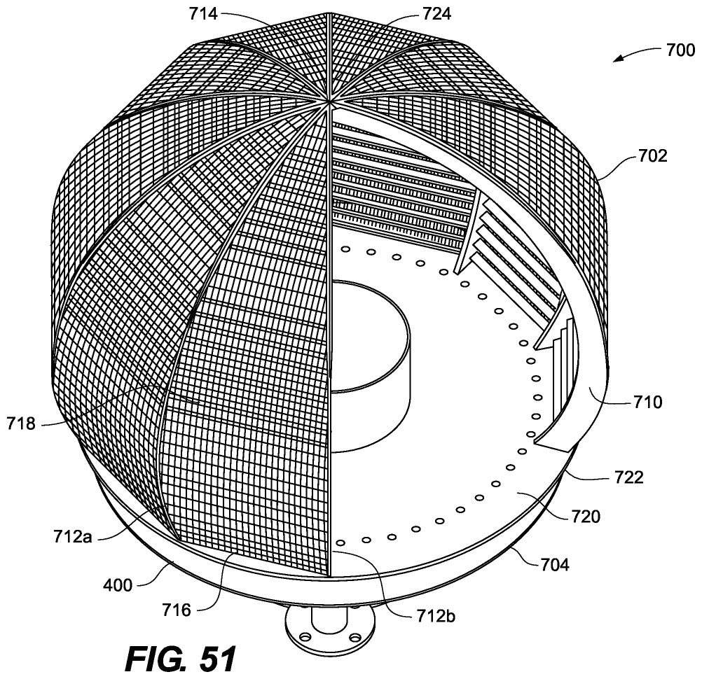

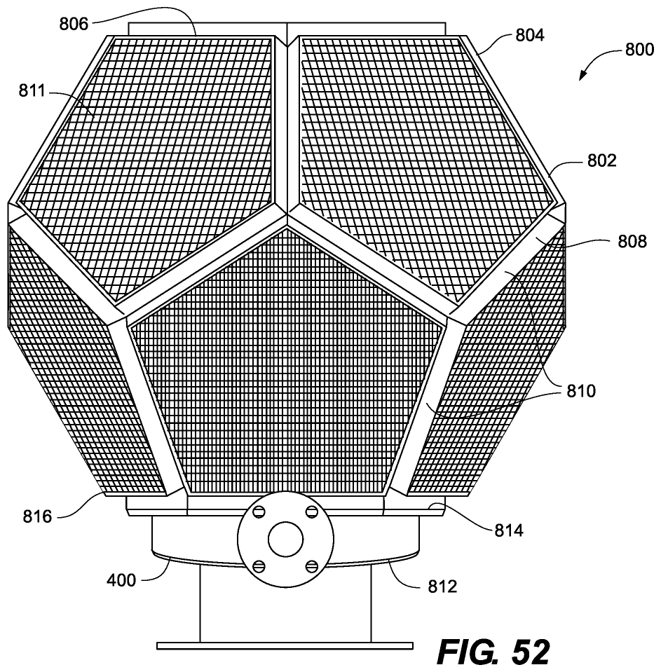

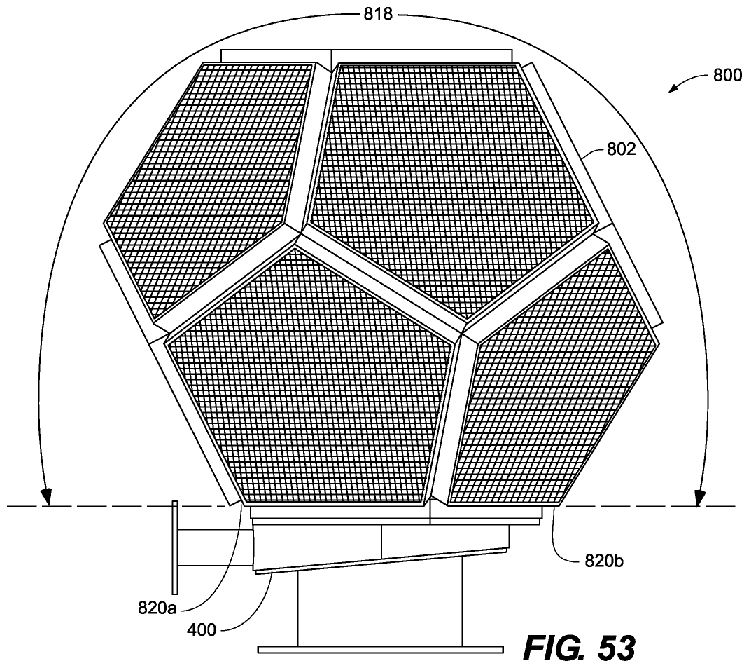

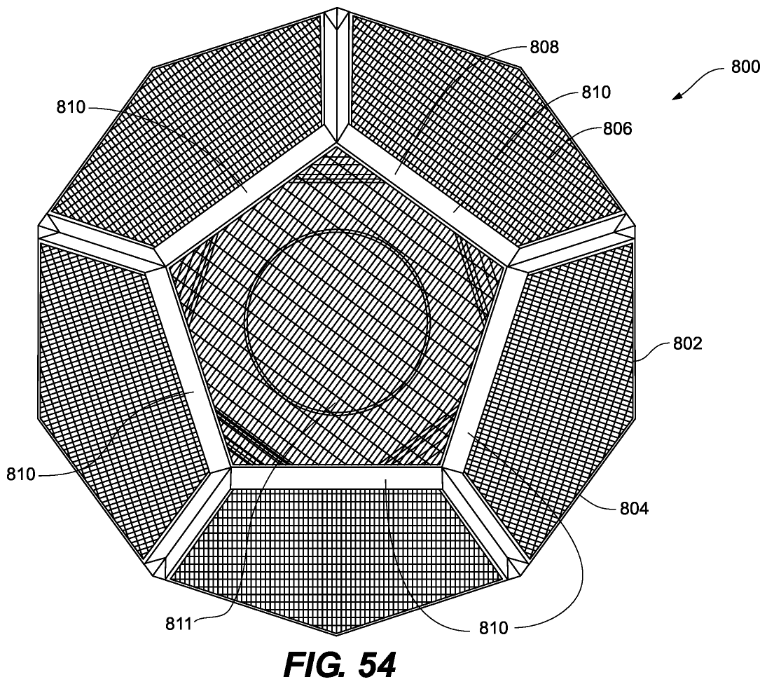

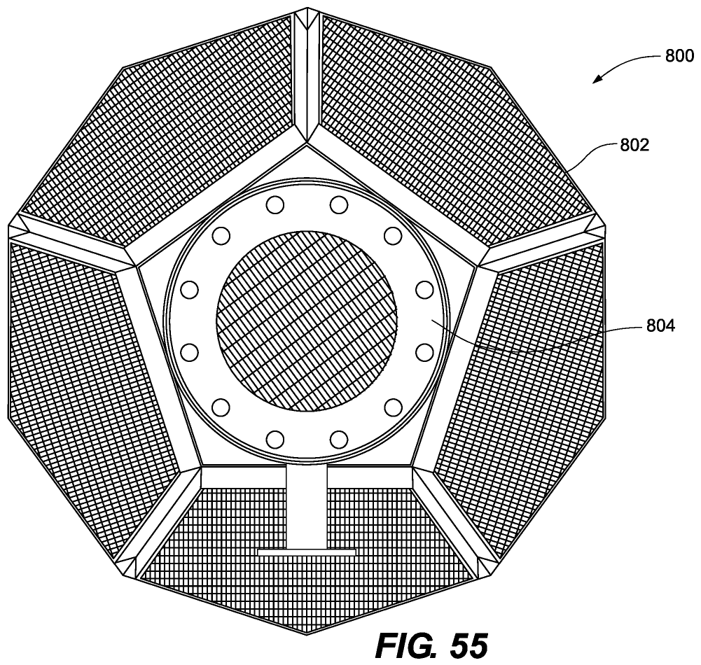

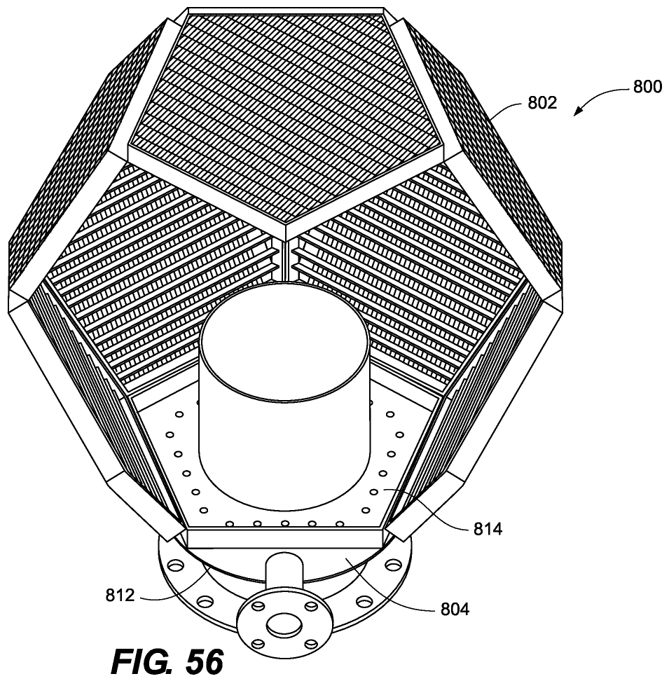

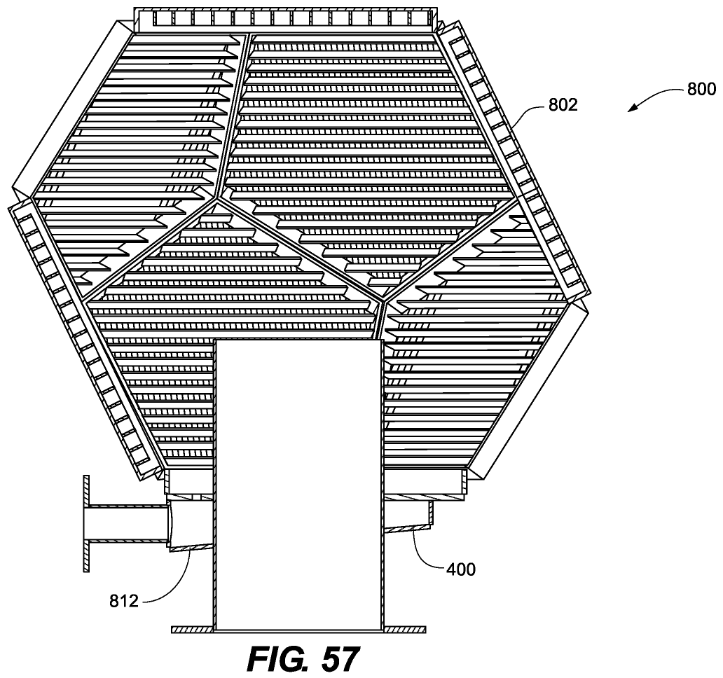

Another variation to intake screen assembly 200 can comprise an intake screen assembly 700 as shown in FIGS. 45, 46, 47, 48, 49, 50 and 51 or an intake screen assembly 800 as shown in FIGS. 52, 53, 54, 55, 56 and 57. Generally, intake screen assemblies 700 and 800 each include a domed upper screen structure wherein the circumference of the domed upper screen structure as measured from an uppermost portion to a lowermost portion of the domed upper structure extends beyond a 180° hemisphere. More specifically, the circumference of the domed upper screen structure from the uppermost portion to the lowermost portion of the domed upper structure is generally greater than 180° and less than 360°.

With specific reference to FIGS. 45-51, the intake screen assembly 700 generally comprises a domed upper screen structure 702 that is operably coupled to a central intake structure 704. Domed upper screen structure 702 is generally defined by a plurality of arcuate filter screens 706 having a truncated elliptical perimeter 708. The truncated elliptical perimeter 708 is defined by a frame 710 having a pair of arcuate sides 712a, 712b, a pointed end 714 and a truncated end 716. Each arcuate filter screen 706 generally includes a screen surface 718 defined by attaching a plurality of parallel wires such as, for example, Vee-Wire® to a plurality of support rods. In this manner, slots are defined between adjacent lengths of the parallel wire such that waters flow from outside the domed upper screen structure 702, through the slots, whereby particulates and debris larger than the slot width are prevented from passing, and into the domed upper screen structure 702.

Central intake structure 704 can substantially resemble the central intake structure 204 including an upper coupling flange 720 to which the domed upper screen structure 702 is operably attached. The upper coupling flange 720 includes a flange perimeter 722 that can comprise an arcuate or rounded perimeter shape or alternatively can be defined by a plurality of flange sides. Generally, the flange perimeter 722 is sized and shaped to accommodate attaching the truncated ends 716 of each arcuate filter screen 706 to the upper coupling flange 720. As the truncated ends 716 of each arcuate filter screen 706 are coupled to the upper coupling flange 720, either via welding or using conventional fasteners, adjacent arcuate filter screens 706 can be operably connected using the adjacent arcuate sides 712a, 712b such that the pointed ends 714 of each arcuate filter screen 706 are positioned in proximity and define an uppermost point 724 of the domed upper screen structure 702. Once assembled, the domed upper screen structure 702 functions in a similar manner and as previously described with respect to the domed or hemispherical upper screen structures previously described including the use of air burst system 400. While the individual arcuate filter screens 706 have been described such that each comprises an individual frame 710, it will be understood that the domed upper screen structure 702 could be constructed in a manner similar to that previously described with respect to the domed upper screen structure 202, for example, the use of a frame structure including interior and exterior frames that cooperatively retain the individual filter screens.

Intake screen assembly 700 generally differs from the intake screen assemblies previously described in that the domed upper screen structure has a dome circumference 726 defined from opposed sides 728a, 728b and through the uppermost point 724 that exceeds 180° and is less than 360°. One advantage of said dome circumference 726 is to decrease the screen radius while maintaining the same screen surface area 730 relative to embodiments in which a similarly defined dome circumference is equal to or less than 180°. As such, this can be advantageous in that a desired amount of screen surface area 730 can be provided in locations that have physical space and other operational limitations in which the desired screen surface area cannot be achieved using a domed upper screen structure where the dome circumference 726 is equal to or less than 180°. In other words, the domed upper screen structure 702 provides a greater screen surface area 730 than another domed upper screen structure sharing the same radius but having a dome circumference 726 that is equal to or less than 180°. Referring now to FIGS. 52-57, intake screen assembly 800 provides similar benefits as those previously described with respect to intake screen assembly 700. However, intake screen assembly 800 differs in that a domed upper screen structure 802 is comprised of flat screen panels that are joined to form a polyhedral shape, for example, a dodecahedron shape 804 defined by a plurality of pentagonal screen panels 806. Generally, each pentagonal screen panel 806 is defined by a shaped frame 808 having a plurality of sides 810. Each pentagonal screen panel 806 includes a screen surface 811 that is generally defined by attaching a plurality of parallel wires such as, for example, Vee-Wire® to a plurality of support rods. In this manner, slots are defined between adjacent lengths of the parallel wire such that waters flow from outside the domed upper screen structure 802, through the slots, whereby particulates and debris larger than the slot width are prevented from passing, and into the domed upper screen structure 802.

Similar to the previously described embodiments, domed upper screen structure 802 can be coupled to central intake structure 812 that can substantially resemble central intake structures 204 and 704 as previously described. The central intake structure 812 can include an upper coupling flange 814 having a flange perimeter 816 that can comprise an arcuate or rounded perimeter shape or alternatively can be defined by a plurality of flange sides. Generally, the flange perimeter 816 is sized and shaped to accommodate attaching the lowest side 810 of the lowermost pentagonal screen panels 806. The geodesic shape 804 is defined by operably coupling adjacent sides 810 of adjacent pentagonal screen panels 806. Connection of the sides 810 to each other or to the upper coupling flange 814 can be accomplished via welding or using conventional fasteners. Once assembled, the domed upper screen structure 802 functions in a similar manner and as previously described with respect to the domed or hemispherical upper screen structures previously described including the use of air burst system 400. While the individual pentagonal screen panels 806 have been described such that each comprises an individual shaped frame 808, it will be understood that the domed upper screen structure 802 could be constructed in a manner similar to that previously described with respect to the domed upper screen structure 202, for example, the use of a frame structure including interior and exterior frames that cooperatively retain the individual filter screens. Domed upper screen structure 802 is similar to domed upper screen structure 702 in that a dome circumference 818 is defined between opposed sides 820a, 820b that exceeds 180° and is less than 360°.

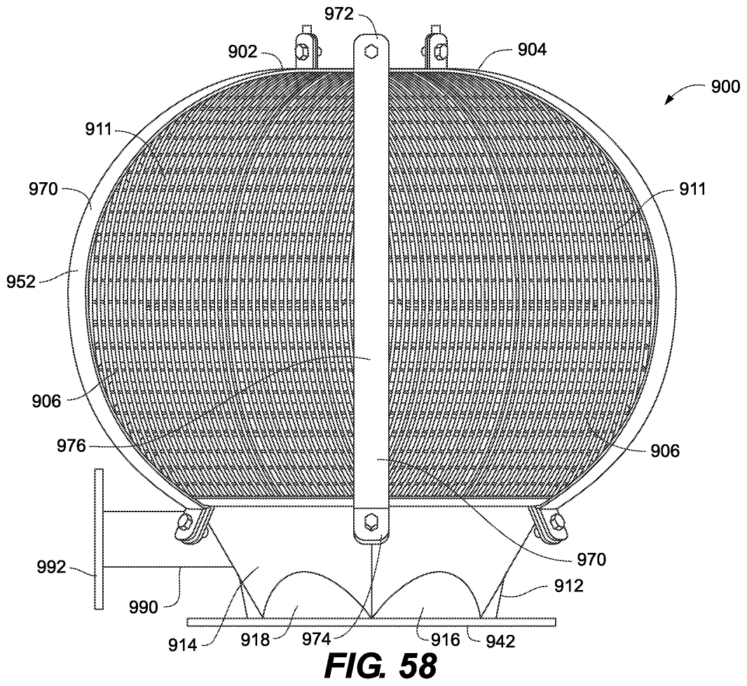

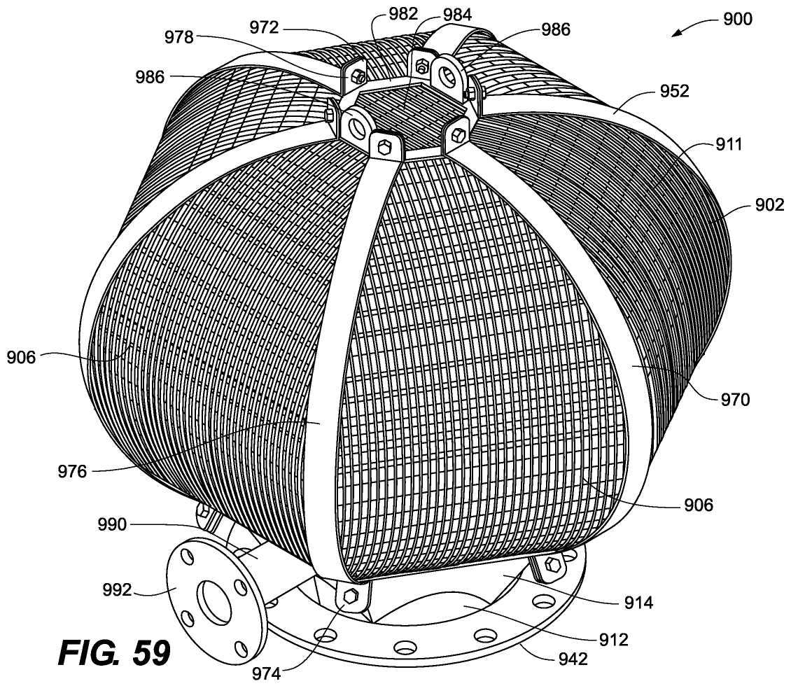

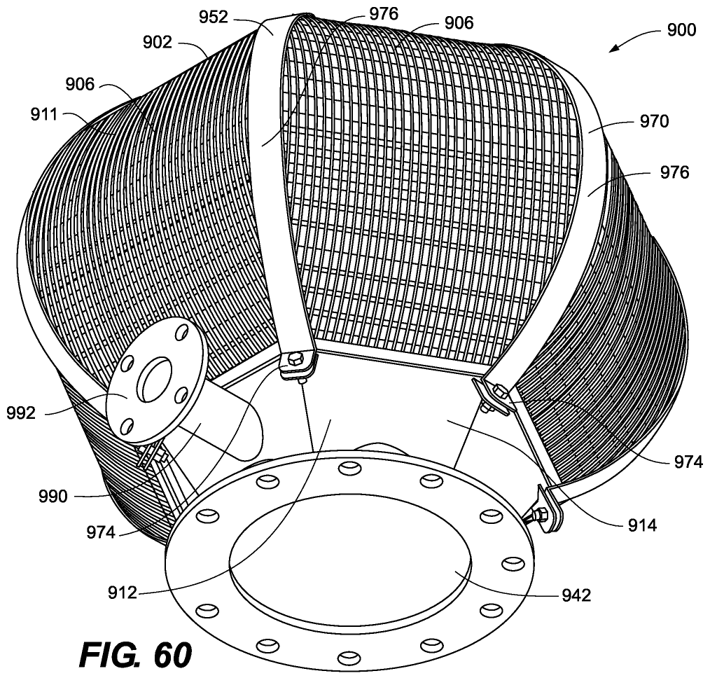

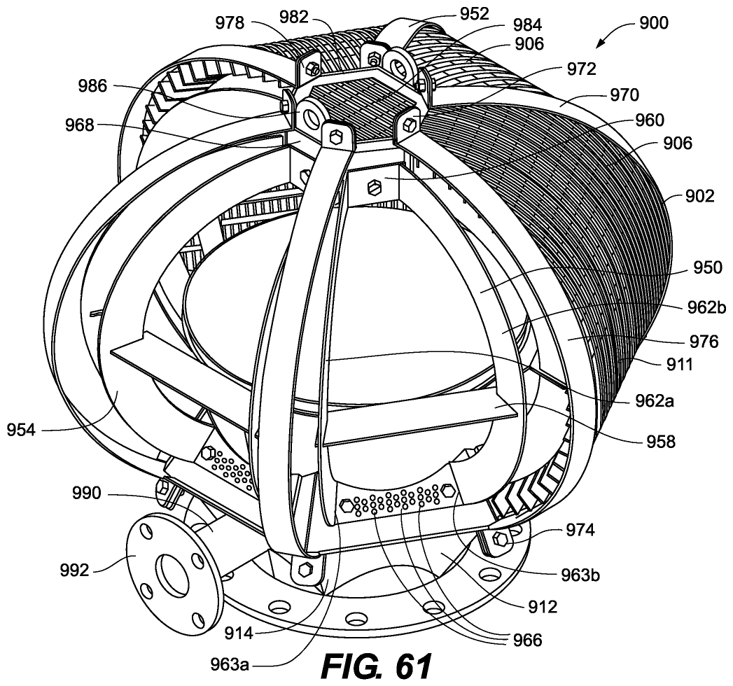

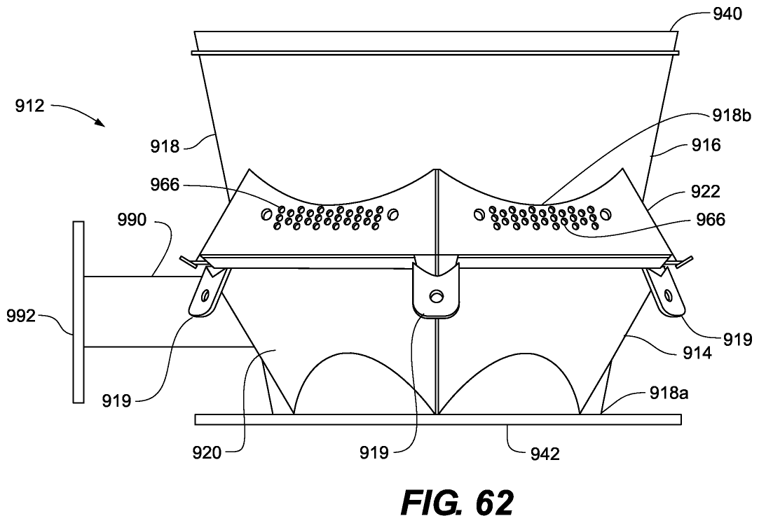

Referring now to FIGS. 58-62, another embodiment of intake screen assembly 900 provides similar benefits as those previously described but incorporating a design in which a central intake structure 912 has been modified such that a central intake flange has been eliminated so as to reduce overall material costs. Generally, intake screen assembly 900 includes a domed upper screen structure 902 comprised of arcuate screen panels 906 that are mounted between an interior frame 950 and an exterior frame 952 and form a partial-toroidal shape 904. Generally, each arcuate screen panel 906 includes a screen surface 911 that is generally defined by attaching a plurality of parallel wires such as, for example, Vee-Wire® to a plurality of support rods. In this manner, slots are defined between adjacent lengths of the parallel wire such that water flows from outside the domed upper screen structure 902, through the slots, whereby particulates and debris larger than the slot width are prevented from passing, and into the domed upper screen structure 902.

Interior frame 950 generally includes a plurality of interior arcuate supports 954, wherein the number of interior arcuate supports 954 corresponds to the number of arcuate screen panels 906. Each interior arcuate support 954 includes an intermediate cross member 958, an upper cross member 960 and a pair of side members 962a, 962b with each side member 962a, 962b having a lower interior flange 963a, 963b. Each upper cross member 960 can be attached to the side of an interior hub 968, wherein the interior hub 968 has a number of sides equal to the number of interior arcuate supports 954. As illustrated, interior hub 968 has a hexagonal shape with six sides. In this way, an upper portion of the interior frame structure 950 is assembled by coupling the upper cross member 960 on each interior arcuate support 954 to a corresponding side of the interior hub 968.

Exterior frame 952 generally comprises a plurality of exterior arcuate supports 970 wherein the number of exterior arcuate supports 970 corresponds to the number of arcuate screen panels 906. Generally, each exterior arcuate support 970 includes an upper flanged portion 972, a lower flanged portion 974 and an arcuate body 976. An upper portion of the exterior frame 952 can be assembly by coupling each upper flanged portion 972 to a corresponding exterior hub flange 978 that projects upward from an exterior hub 982. The number of exterior hub flanges 978 will be equal to the number of upper flanged portions 972. As illustrated, the exterior hub 982 includes six exterior hub flanges 978 such that the exterior hub has a hexagonal shape. Due to the nature of the partial-toroidal shape 904, exterior hub 982 can be fabricated to have an exterior solid plate or alternatively, and as illustrated, exterior hub 982 can include a hub screen panel 984 fabricated in a manner similar that of the arcuate screen panel 906. Exterior hub 982 can further comprise one or more lifting lugs 986 to facilitate lifting and placement of the intake screen 900.

Similar to the previously described embodiments, domed upper screen structure 902 can be coupled to central intake structure 912. Central intake structure 912 differs from the central intake structures previously described, for example, central intake structures 204 and 704, as the domed upper screen structure 902 can be mounted to a perimeter mounting assembly 914 that is coupled to and surrounds a sidewall 916 on an intake pipe 918. Intake pipe 918 can be fabricated such than an intake opening 940 is larger than an intake exit 942. As such, sidewall 916 is angled between the intake opening 940 and intake exit 942. Generally, the perimeter mounting assembly 914 can include a lower member 920 that is coupled near a lower portion 918a of the sidewall 916 and an upper member 922 that is coupled to an intermediate portion 918b that is between the lower portion 918a and the intake opening 940. Upper member 922 generally includes a plurality of apertures 966. Generally, the interior frame 950 can be attached to the upper member 922 by coupling the lower interior flanges 963a, 963b on opposed side of the upper member 922. The exterior frame 952 can be coupled to the lower member 920 by coupling the lower flanged portions 974 to corresponding mounting flanges 919 that project from the lower members 920. Once assembled, the domed upper screen structure 902 functions in a similar manner and as previously described with respect to the domed or hemispherical upper screen structures previously described.

Due to the lack of a central intake flange, intake system 900 includes an air burst system 990 that is different than that previously described with respect to air burst system 400. With air burst system 990, an air burst pipe 992 is attached to the perimeter mounting assembly 914, and more specifically, through one of the lower members 920 so as to be in fluid communication with a mounting assembly interior defined between the perimeter mounting assembly 914 and the sidewall 916. When desired, a pressurized air burst can be introduced through the air burst pipe 992 and into the perimeter mounting assembly 914 such that the pressurized air burst can travel through the apertures 966 to access an interior portion 996 of the domed upper screen structure 902.

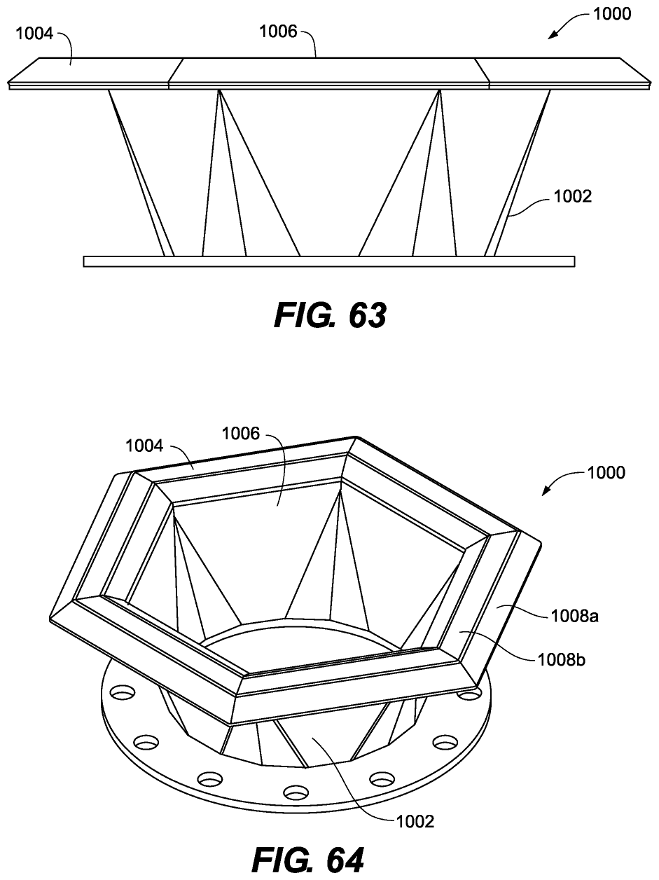

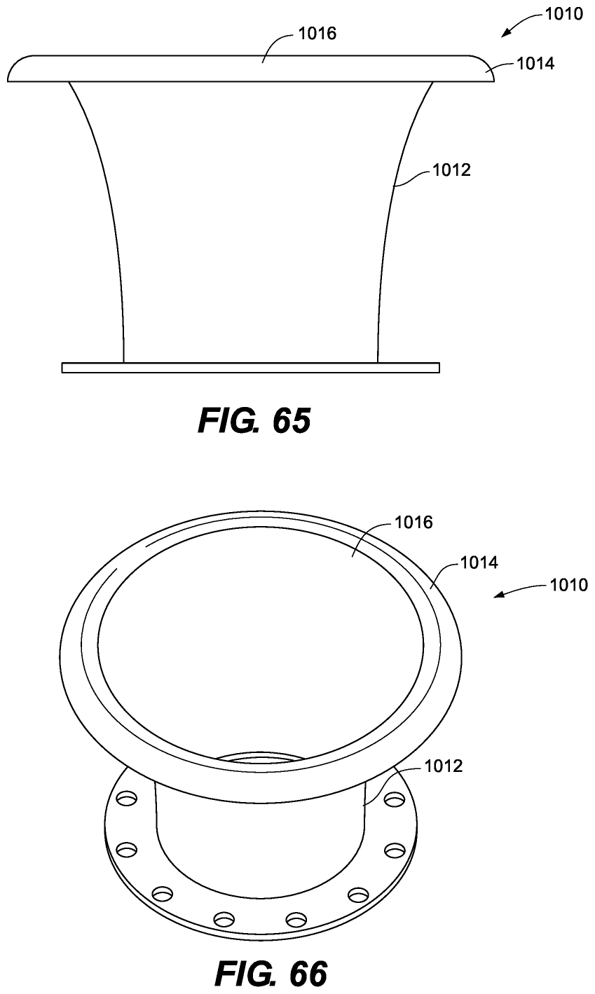

Referring now to FIGS. 63-66, variations of intake pipes can be utilized in place of intake pipe 918 to further improve performance related to the shape of the key flow velocity isosurface and pressure drop. For instance, an intake pipe 1000 can include an angled side wall 1002 with an upper lip 1004 at a pipe inlet 1006 as shown in FIGS. 63 and 64. As illustrated, upper lip 1004 can be formed of multiple surface 1008a, 1008b. Alternatively, an intake pipe 1010 as shown in FIGS. 65 and 66 can include an arcuate side wall 1012 with an arcuate upper lip 1014 at a pipe inlet 1016. By adjusting the shape of the sidewalls and upper lips, a designer can adjust various flow characteristics at the pipe inlet 1006/1016 and adjust the shape of the key flow velocity isosurface as desired. Although not shown, the upper lip 1004/1014 can contain a plurality of apertures to be used as part of the air burst system.

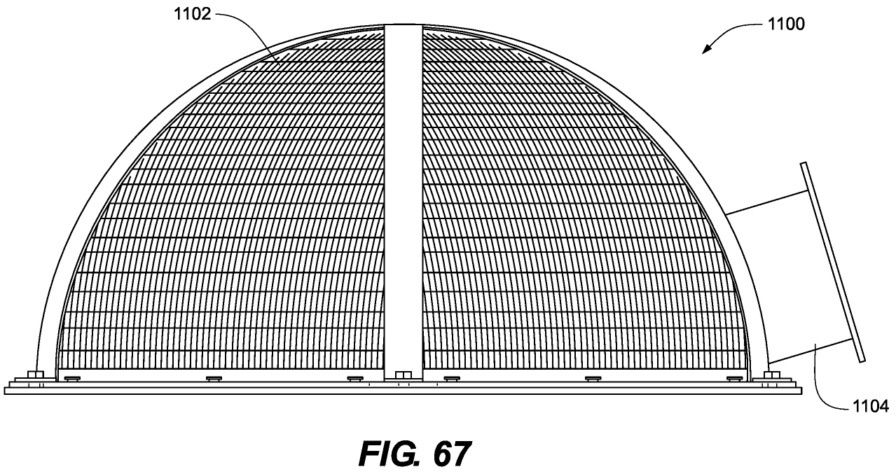

As shown in FIG. 67, an alternative embodiment of an intake screen assembly 1100 can be constructed for use shallow or reduced depth locations. Generally, intake screen assembly 100 can include a domed or dome-like upper screen structure 1102 that substantially resembles the domed or hemispherical upper screen structure 202. What distinguishes intake screen assembly 1100 from the previously disclosed embodiments is the inclusion of a side access central intake structure 1104, as opposed to the bottom access version of the other embodiments. Side access central intake structure 1104 can be similarly applied to any of the disclosed embodiments, and as discussed, can be especially relevant in shallow or reduced depth locations.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. An intake screen assembly, comprising:
a domed or dome-like upper screen structure approximating a non-developable screen shape and defining an interior portion, the domed or dome-like upper screen structure formed from a plurality of filter screens, each of the plurality of filter screens having a developable shape and including a screen surface; and
a central intake structure including an intake pipe defining a central aperture,
wherein the domed or dome-like upper screen structure is attached to the central intake structure such that the central aperture is within the interior portion,
wherein a key flow velocity isosurface is defined by a screened water flow into the central aperture, said key flow velocity isosurface defining a non-developable shape about the central aperture, and
wherein the interior portion is configured to closely encompass said non-developable shape.

2. The intake screen assembly of claim 1, wherein the screen surface of each of the plurality of filter screens comprises an arcuate screen surface.

3. The intake assembly of claim 2, wherein the non-developable shape of the domed upper screen structure comprises a hemisphere.

4. The intake assembly of claim 2, wherein the non-developable shape of the domed upper screen structure defines a dome circumference measured between a pair of opposed sides and through an uppermost point of the domed upper screen structure, said dome circumference being greater than 1800 and less than 360°.

5. The intake assembly of claim 2, wherein the non-developable shape of the domed upper screen structure comprises a partial toroidal shape.

6. The intake assembly of claim 1, wherein the screen surface of each of the plurality of filter screens comprises a flat screen surface,

7. The intake assembly of claim 6, wherein the domed upper screen structure comprises a polyhedral shape.

8. The intake assembly of claim 1, wherein the central intake structure includes an upper coupling flange.

9. The intake screen assembly of claim 8, wherein the domed upper screen structure further comprises a frame structure, wherein the frame structure attaches to the upper coupling flange.

10. The intake screen assembly of claim 9, wherein the frame structure comprises an interior frame and an exterior frame, wherein the plurality of filter screens are retainably captured between the interior frame and the exterior frame.

11. The intake screen assembly of claim 10, wherein the interior frame is welded to the upper coupling flange.

12. The intake screen assembly of claim 11, wherein the exterior frame is detachably coupled to the upper coupling flange.

13. The intake screen assembly of claim 1, wherein the intake pipe has a pipe diameter equal to the central aperture.

14. The intake screen assembly of claim 1, wherein the intake pipe has an upper portion and a lower portion, wherein the upper portion has an upper diameter equal to the central aperture and the lower portion has a lower diameter less than the upper diameter.

15. The intake screen assembly of claim 1, wherein the intake pipe has a tapered, conical portion fluidly coupled to the central aperture, the tapered, conical portion tapering to a lower portion of the intake pipe, wherein the lower portion has a lower diameter less than a central aperture diameter of the central aperture.

16. The intake screen assembly of claim 1, wherein the intake pipe has a flared portion defining the central aperture.

17. The intake screen assembly of claim 1, further comprising:
an air burst system surrounding the intake pipe, the air burst system fluidly coupled to the interior portion of the domed upper screen structure.

18. The intake screen assembly of claim 17 wherein the air burst system is operably coupled to a bottom flange surface of an upper coupling flange on the intake pipe, the upper coupling flange having a plurality of air burst apertures surrounding the central aperture, the air burst apertures fluidly coupling the air burst system and the interior portion of the hemispherical upper screen structure.

19. The intake screen assembly of claim 18, wherein the air burst system comprises a circular backwash duct defined by the bottom flange surface, a pair of side walls and a bottom duct wall, wherein an air burst inlet pipe is fluidly connected to the bottom or side duct wall.

20. The intake screen assembly of claim 19, wherein the circular backwash duct defines a duct cross-section, said duct cross-section decreasing from the air burst inlet pipe to an opposed duct location that is opposite the air burst inlet pipe.

21. The intake screen assembly of claim 19, wherein the duct cross-section is decreased by selectively decreasing one or both of a wall height or a duct width as the circular backwash duct approaches the opposed duct location.

22. The intake screen assembly of claim 1, wherein the a central intake structure comprises a side access central intake structure.

23. A method for managing flow velocity across a screen surface of an intake screen assembly, comprising:
attaching a domed or dome-like upper screen structure to a central intake structure, wherein an interior portion of the domed or dome-like upper screen structure is configured to closely encompass a key flow velocity isosurface defined about a central inlet aperture of the central intake structure.

24. The method of claim 23, wherein the step of attaching the domed or dome-like upper screen structure further comprises:
coupling the domed or dome-like upper screen structure to an upper coupling flange on the central intake structure.

25. The method of claim 23, wherein the step of attaching the domed or dome-like upper screen structure further comprises:
coupling the domed or dome-like upper screen structure to a sidewall of an intake pipe of the central intake structure.

26. The method of claim 23, wherein the step of attaching the domed or dome-like upper screen structure further comprises:
attaching an interior frame to the central intake structure,
positioning a plurality of screens against the interior frame; and
attaching an exterior frame to the central intake structure such that the plurality of filter screens are retained between the interior frame and an exterior frame.

27. The method of claim 23, wherein the step of attaching the domed or dome-like upper screen structure further comprises:
welding the plurality of screens together to form the domed or dome-like upper screen structure.

28. A method for backwashing a domed or dome-like intake screen, comprising:
coupling an air burst system to a central intake structure that is located below an upper domed or dome-like screen;
supplying pressurized air to the air burst system; and
directing the pressurized air through a plurality of air burst apertures proximate a lower portion of the upper domed or dome-like screen.

29. The method of claim 28, wherein the step of coupling the air burst system to the central intake structure comprises:
attaching the air burst system to an intake flange defining an upper flange surface and a lower flange surface, wherein the domed or dome-like screen engages the upper flange surface and wherein the air burst system engages the lower flange surface and said plurality of air burst apertures extend between the lower flange surface and the upper flange surface.

30. The method of claim 28, wherein the step of coupling the air burst system to the central intake structure comprises:
attaching the air burst system to a mounting assembly on a sidewall of the central intake structure, wherein the domed or dome-like screen engages the mounting assembly and wherein the plurality of air burst apertures extend through the mounting assembly.
